(19) United States
(12) Patent Application Publication
(10) Pub. No.: US 2002/0099592 A1
(43) Pub. Date: Jul. 25, 2002

(54) Method and apparatus for providing best practice reports for real estate transactions using a computer network

(76) Inventor: John J. Donahue, Melrose, MA (US)

Correspondence Address: Banner & Witcoff, Ltd., 1001 G Street, N.W., Washington, DC, 20001-4597, US

(21) Appl. No.: 09/765,645

(22) Filed: Jan. 22, 2001

(51) Int. Cl. G06F 17/60

(52) U.S. Cl. 705/10

(57) ABSTRACT

The invention provides a method and apparatus for providing best practice reports including information related to completed real estate transactions and services provided by third party vendors used to complete real estate transactions. A party to a real estate transaction provides information regarding the transaction over a computer network. The information is used to generate reports that include user comments and evaluations of services provided by one or more local service providers. The reports are stored in a database connected to the web site. Third-party users can retrieve reports based on various criteria. Local service providers can also access information stored in the database, and can provide comments relating to the reports, which are linked to the reports.

### RELATED APPLICATIONS

This application is related in subject matter to pending U.S. application Ser. No. 09/610,005, entitled “Method And Apparatus For Negotiating A Real Estate Lease Using A Computer Network” and filed on Jul. 5, 2000.

### BACKGROUND OF THE INVENTION

1. Technical Field

This invention relates generally to electronic commerce and the Internet. More particularly, the invention provides a method and apparatus for receiving information related to completed real estate transactions over a computer network, such as the Internet, and creating a database of best practice reports including the received information.

2. Related Information

Corporations frequently need to lease real estate in the form of offices, laboratories, warehouses, and other spaces. Alternatively, companies sometimes have surplus office space that could be sublet to tenants for profit or cost recovery.

Typically, companies will hire real estate brokers to search for and conduct preliminary negotiations regarding potential leasing arrangements. After preliminary details have been worked out, lawyers acting on behalf of the prospective landlords and tenants negotiate a detailed lease agreement. This process may involve numerous meetings, telephone calls, faxes, exchanges of draft documents, and the like. It also may involve various middlemen in addition to lawyers and real estate brokers. For example, if architectural or mechanical improvements are needed, one or both of the parties may hire outside contractors (e.g., architects or engineers) to assist in evaluation of lease properties and/or to propose modifications to the property.

Various web-based listing services have sprung up in recent years to service the real estate needs of companies looking for space, including sales, leases, and auctions. Companies such as Loopnet (www.loopnet.com), PropertyFirst (www.propertyfirst.com), and EGPropertyLink (www.egpropertylink.co.uk) provide brokerage and listing services in an attempt to facilitate real estate transactions over the Internet. These services primarily focus on listing properties, and do little to facilitate the negotiation or consummation of real estate deals. In particular, these services do not provide process management tools to guide landlords and tenants through a structured deal. Furthermore, these services fail to evaluate the effectiveness of service providers, such as brokers and architects.

The negotiation of real estate leases between parties located in different countries involves various inefficiencies and drawbacks. For example, because of different time zones, the times available for parties to meet or hold telephone conferences may be limited. Differences in currencies (e.g., dollars versus Euros) and metrics (e.g., square feet versus square meters) add complexity to the negotiation process, thus driving up costs. Language barriers may also add additional costs.

It may be difficult for a U.S.-based prospective tenant to hire service providers, such as architects, in another country. More than likely, referrals for service providers in other countries are not available. Consequently, the U.S.-based prospective tenant may not be able to locate a service provider in another country. Even if a service provider is located, the quality of the service provided by the service provider may not be known. Poor service provided by a service provider could lead to costly delays for completing a real estate transaction, such as a lease.

Furthermore, the procedures and customs used by foreign real estate brokers and intermediaries to negotiate a corporate lease may be different depending on the country, language, and regulations. Legal documents drafted in one country may look substantially different from those typically drafted under U.S. laws and customs. These and other differences have made it very costly to negotiate leases for commercial office space across international borders.

### SUMMARY OF THE INVENTION

The present invention overcomes the aforementioned problems by providing a method and apparatus that facilitates a structured lease negotiation between two parties to a real estate transaction. Also, the present invention provides a method and apparatus for providing best practice reports that include information related to completed real estate transactions and services provided by third party vendors used to complete real estate transactions.

According to one variation of the method for facilitating a structured lease negotiation, a series of predefined milestone negotiation steps are executed on a computer that couples two parties through a network, such as the Internet. Parties to the transaction answer predefined questions regarding a proposed transaction in such a manner that certain aspects of the transaction can be agreed upon early during the negotiation process while others are deferred to later phases. Additional steps of completing the lease transaction can also be included in the inventive method.

In one variation of the invention, the parties answer questions and exchange information without the simultaneous participation of each participant, such that a structured negotiation takes place over a period of time, possibly in different time zones. In each phase, parties must select from a predefined list of actions (e.g., agree or defer) associated with a particular aspect of the negotiation (e.g., rent to be charged, term of the lease, etc.). Provisions that are agreeable to both parties are “locked in” while those for which no immediate agreement can be reached are deferred and negotiated in a subsequent phase. Certain lease provisions may have subsidiary actions (e.g., lower-level agreements and deferrals) that can then be “rolled up” to the phase-level negotiation. Tools are provided to facilitate transnational aspects of the negotiation (e.g., conversion between currencies, metrics, or languages). A computer generates intermediate documents that assist in the negotiation (e.g., draft proposal letters) and identifies areas that require further negotiation.

If parties indicate that outside help is needed to define part of the contract (e.g., architect review of an office layout), a computer suggests vendors located in the geographic area of the lease property and transmits via e-mail a draft scope of services request to one or more vendors. Each party identifies corporate approvals required to complete the negotiation, and a computer-generated lease document can be printed for signatures. Feedback from the parties in the form of problems encountered and solutions achieved during the negotiation process are collected and stored in a database for review and use by other future negotiation parties.

According to a variation of the method for providing best practice reports, a user provides information regarding a completed real estate transaction and services provided by one or more local service providers (LSPs) used to complete the transaction. A real estate transaction includes any transaction related to the transfer of real estate and can include, for example, a lease, sale, purchase, assignment, contract with an LSP, contracts between LSPs and contractors and other transactions related to the transfer of real estate. A user can include any participant in the real estate transaction process (e.g., corporate end user, landlord/tenant, real estate owner/purchaser, investors, LSPs and the like) or any entity registered to use the best practice report service provided by a computer. An LSP can include a third party that provides goods and/or services used to complete a real estate transaction. An LSP can include, for example, a real estate broker, appraiser, lawyer, mediator, architect, contractor and the like. Terms such as “participant,” “partner,” and others when referring to parties or users of the inventive system should be interpreted broadly and without limitation. The method for providing best practice reports can be practiced separately from a lease negotiation and separate and apart from the structured negotiation processes described herein.

One or more best practice reports including, among other things, evaluations of the transaction and of the LSPs are generated from the information. A best practice report generally describes an experience in satisfying a particular real estate-related requirement. A best practice report can include, for example, a description of the tasks required to complete one or more steps in the process for completing a real estate transaction; an evaluation of the role and effectiveness of other participants in the process (including tenants, landlords, property owners, LSPs and other vendors); details of location-specific issues that impact the successful completion of the transaction (e.g., local customs, market practices or difficulties negotiating with decision makers that are resident in another country); and advice to fellow participants as to how similar requirements may be best satisfied in the future.

Generated best practice reports can include a transaction best practice report, including information that summarizes a completed transaction; and an LSP best practice report, including information summarizing experiences with one or more LSPs used during execution of the transaction. In addition to providing evaluations of LSPs, best practice reports can include evaluations of landlords/tenants, real estate owners/purchasers and other participants involved in the completion of a real estate transaction. Also, instead of generating two distinct reports, a single best practice report can be generated including all the information that a transaction best practice report and related LSP best practice reports would include.

Best practice reports are stored in a database, and users can access the database to retrieve stored best practice reports. For example, prior to entering into negotiations with a party, a user can review comments in best practice reports that concern the party's behavior during a previous real estate transaction. Similarly, prior to retaining an LSP a user may review best practice reports that evaluate the LSP. Therefore, best practice reports can serve as valuable research and analysis tools that can save time and money for a party entering into a real estate transaction.

Real estate transactions are complicated processes involving a number of different participants, each of whom has their own vested interests. A service providing best practice reports can serve as a neutral platform (i.e., not necessarily controlled by landlords, property owners, or LSPs) that provides objective evaluations for parties engaging in the sale of real estate, lease of real estate or other real estate transactions.

Other features and advantages of the invention will become apparent with reference to the following detailed description and the figures.

### BRIEF DESCRIPTION OF THE DRAWINGS

FIG. 1A shows a system for facilitating a real estate lease transaction between a prospective tenant and prospective landlord using a computer-driven structured negotiation technique.

FIG. 1B shows a computer-implemented method for allowing two parties to negotiate a lease transaction using structured negotiation phases.

FIG. 2 shows a nine-phase computer-assisted process for negotiating and executing a lease transaction between a tenant and a landlord.

FIG. 3 shows additional details of the first phase.

FIG. 4 shows additional details of the second phase.

FIG. 5 shows additional details of the third phase.

FIG. 6 shows additional details of the fourth phase.

FIG. 7 shows additional details of the fifth phase.

FIG. 8 shows additional details of the sixth phase.

FIG. 9 shows additional details of the seventh phase.

FIG. 10 shows additional details of the eighth phase.

FIGS. 11A-C show a process for creating a best practice report.

FIG. 12 shows a web-based computer screen presenting top-level choices for each phase of a nine-phase negotiation and execution process.

FIG. 13 shows a web-based computer screen in which a prospective tenant and landlord select predefined choices for lease provisions in a first phase.

FIG. 14 shows a web-based computer screen for negotiating details of one lease provision.

FIG. 15 shows a web-based computer screen in which a prospective tenant and landlord select predefined choices for resolving deferred lease provisions in a second phase.

FIG. 16 shows a computer-generated lease proposal to be filled in by one or both of the parties.

FIGS. 17A and 17B show a computer-generated preview of a lease proposal to be agreed between the parties.

FIG. 18 shows a computer-generated schedule for each phase of a nine-phase lease negotiation and execution process.

FIGS. 19A and 19B show a computer-generated request for proposal for a local service provider.

FIGS. 20-23 show exemplary web-based computer screens for entering information used to generate best practice reports.

FIGS. 24A and 24B show examples of a transaction best practice report and an LSP best practice report respectively.

### DETAILED DESCRIPTION OF THE PREFERRED EMBODIMENTS

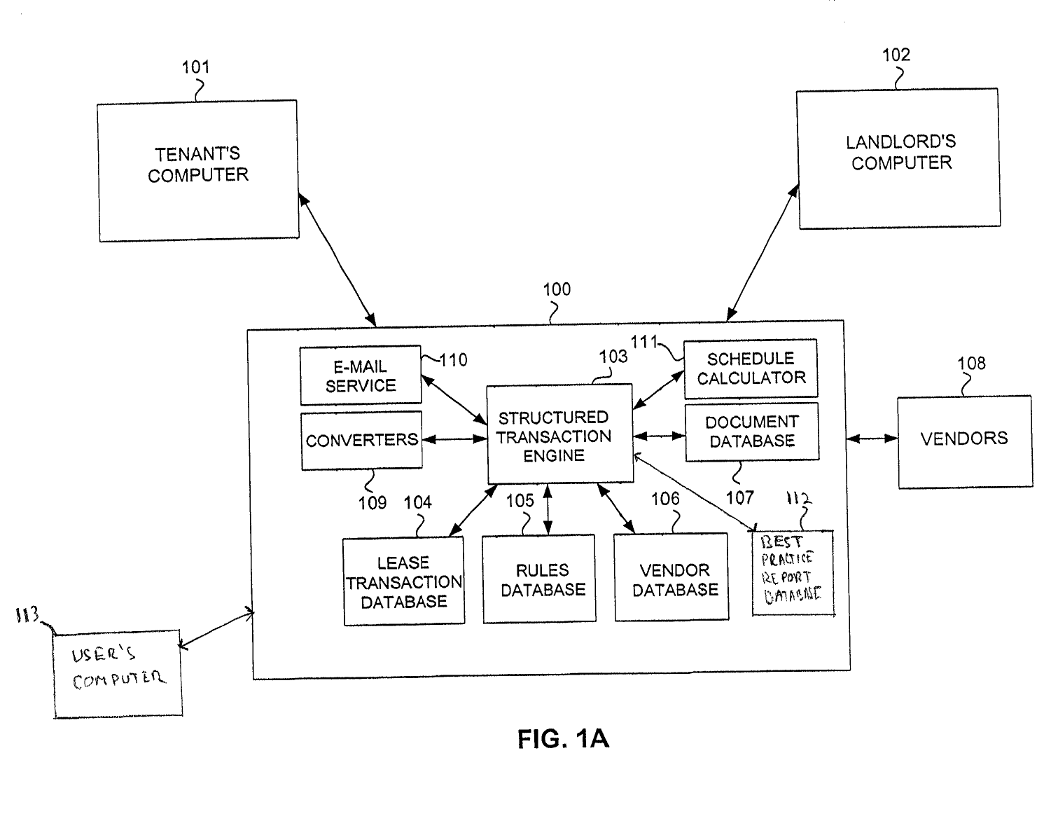

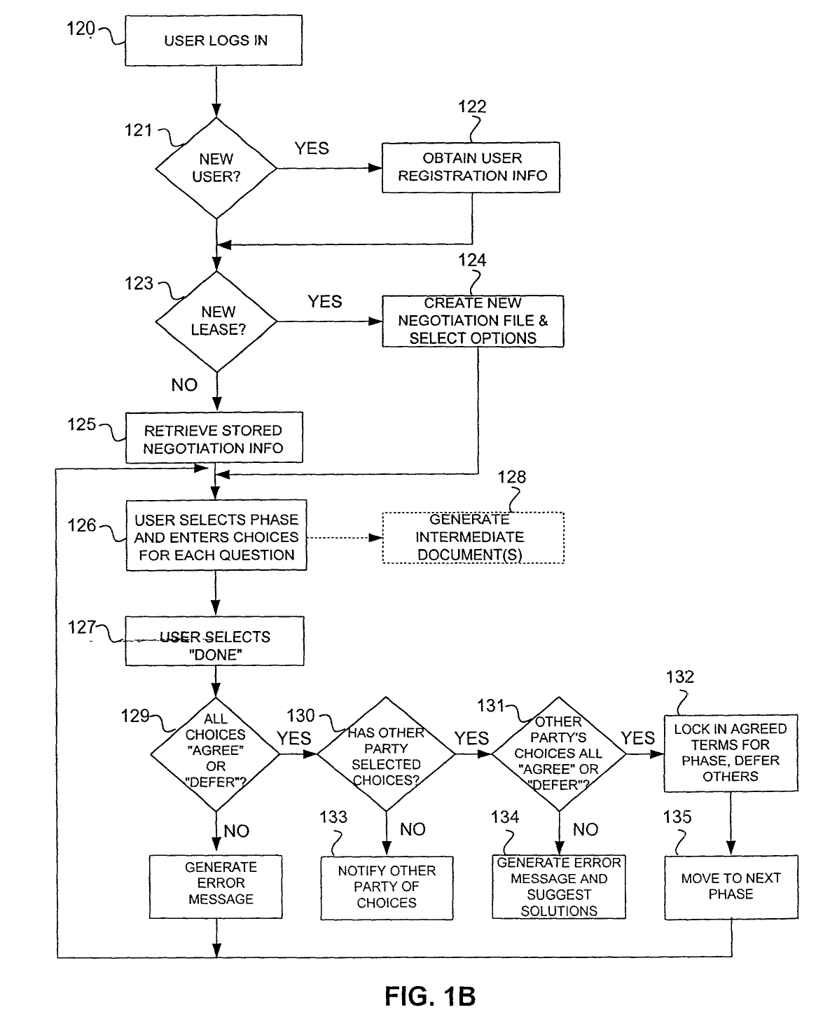

FIG. 1A shows a system for facilitating a real estate lease transaction between a tenant and a landlord. Although the terms “landlord” and “tenant” will be used generally to refer to actual parties to a lease negotiation, those terms also encompass agents or others acting on behalf of the ultimate landlord or tenant. It is also possible that there will be more than one landlord or tenant to a transaction. It should also be understood that a tenant in one context could in fact act as a landlord in another context. For example, a tenant that needs to dispose of part of a leasehold interest could be considered a landlord in the context of the invention. A landlord having an existing lease with a tenant may act in concert with the tenant to sublet the property to another tenant; in that context, the landlord and original tenant could both be considered landlords while the prospective new lessee would be the tenant. In summary, the terms “landlord” and “tenant” may have a variety of meanings dictated by the particular context.

According to the system of FIG. 1A, a prospective tenant operates a computer 101 to negotiate a real estate lease with a prospective landlord, who operates a separate computer 102. The parties negotiate the lease through a computer 100 that implements a structured transaction. Computer 100 may comprise a web site that stores and generates web pages accessible over the Internet to both parties, each of whom may be located in different countries and time zones. Additionally, one or more third-party vendor computers 108 (e.g., LSPs) may also communicate with computer 100 as described in more detail herein. Alternatively, the functions associated with computer 100 can be implemented in computer 101 or 102, or a combination of the two computers, such that no physical third computer is required.

According to one aspect of the invention, each lease is negotiated using a computer-implemented process that guides the parties through various negotiation phases. Although the invention will be described with reference to a nine-phase negotiation and execution process, the invention is not limited in this respect, and it will be appreciated that a different number of negotiation phases can be used without departing from the scope of the invention. Any or all of the steps described herein can be implemented in software and stored on computer-readable media for execution in a computer.

In one embodiment, a structured transaction engine 103 controls the negotiation process by displaying web pages containing predefined choices for various aspects of the transaction within each negotiation phase, and by comparing choices made by each party on each web page to rules stored in a rules database 105. Rules database 105 and engine 103 can comprise an expert system or other type of knowledge base that stores information concerning allowable inputs from each user for each phase. Alternatively, the logic used to control the operation of the negotiation (and to flag errors or conflicting information entered by users) can be incorporated into software using a procedural or object-oriented language.

Structured transaction engine 103 stores information entered by each party into a lease transaction database 104, which maintains information concerning each evolving lease negotiation. Multiple leases may simultaneously be under negotiation at any one time among different sets of negotiators, such that lease transaction database 104 contains information for different leases in various stages of negotiation. Vendor database 106 contains information concerning various third-party vendors (e.g., architects, engineers, lawyers, interior designers, and the like) and their associated contact information (e.g., city, country, e-mail address, telephone and fax number). Document database 107 contains certain standard document templates that can be used to construct a completed lease and other intermediate documents based on information provided by the parties during the negotiation process.

One or more converters 109 provide conversion functions (e.g., Euros to dollars, square feet to square meters, and vice versa) to facilitate the negotiation of particular aspects of each lease. An e-mail service 110 can also be included to allow parties to a negotiation to transmit and receive messages, including attachments such as draft documents, during the negotiation process. Schedule calculator 111 calculates a proposed schedule corresponding to milestones during the negotiation and execution phase, based on average actual lengths of time stored in a database. In one variation, the lengths of time stored in the database are based on or derived from previously negotiated contracts (i.e., real-world practice is used to project future schedules). For example, if over the course of five different negotiated leases the average amount of time needed to go from generating a draft lease to moving into the leased property is two months, the scheduler would use that value to schedule such a milestone two months before the lease move-in date.

According to another aspect of the invention, the parties answer questions presented on web pages according to a computer-implemented transaction sequence, such that the parties can quickly identify areas of agreement and resolve areas of disagreement in an efficient manner. The lease negotiation can be conducted across great distances (e.g., across the Atlantic Ocean) and in different time zones through the use of a computer network such as the Internet. Because both parties are forced to conform to a highly structured, well-defined transaction sequence for negotiation, errors and misunderstandings can be greatly reduced. Moreover, computer software can be used to quickly identify areas of agreement and offer alternatives for resolving areas of disagreement.

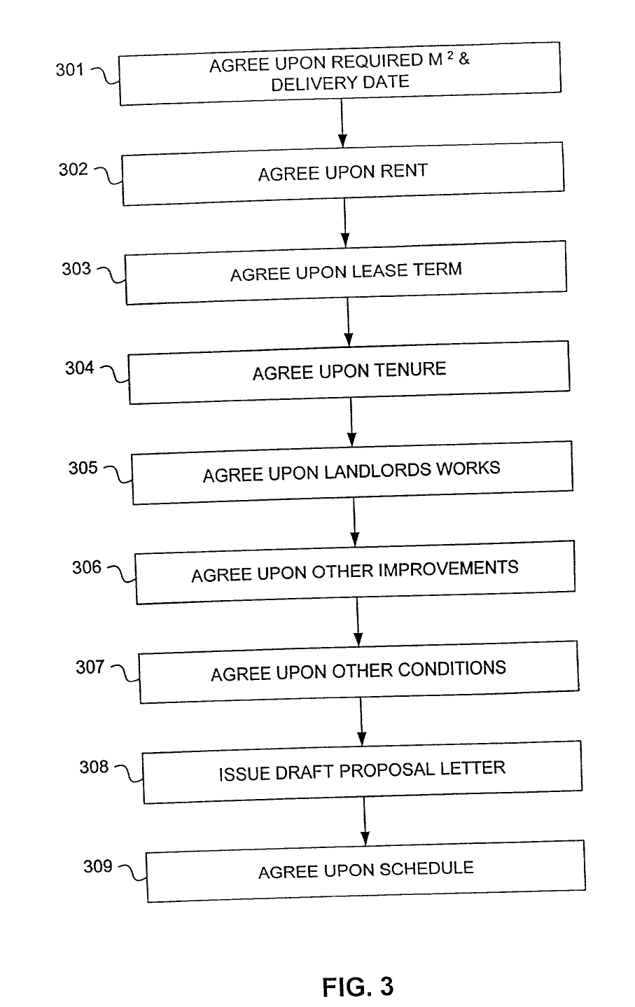

In accordance with another aspect of the present invention, users connected to computer 100 can create and access best practice reports stored in best practice report database 112. A user can include any participant in the real estate transaction process (including the phases described in FIGS. 3 to 11) or any entity registered to use the services provided by computer 100. Users access computer 100 via any one of computers 101, 102, and 113 for creating and accessing stored best practice reports. In one embodiment, an operator of the system can charge a fee for access to best practice reports database 112, thus allowing prospective parties to a new real estate transaction to “buy” experience reflected in the database.

Best practice reports summarize a user's experience in completing a real estate transaction. For example, one or more best practice reports may describe the current local real estate market conditions and include evaluations of LSPs used to complete a real estate transaction. LSPs may include third party vendors (e.g., real estate brokers, appraisers, lawyers, mediators, architects, contractors, etc.) that provide goods or services that can be used to facilitate a real estate transaction. A database of best practice reports can serve as a valuable research and analysis tool for parties intending to enter into real estate transactions.

In one embodiment, structured transaction engine 103 controls processes for generating and providing access to stored best practice reports via displayed web pages. For example, a web page containing predefined fields (e.g., fields contained in a questionnaire) is displayed to a user completing a lease negotiation transaction. A field in a web page includes a section of the web page that requests or provides information. The web pages can include preformatted selections (e.g., a check list or drop-down menu) and open text boxes for inputting information for the fields. The user inputs information for the fields pertaining to the completed transaction, and a best practice report is generated from the input information. The generated best practice report may include some or all of the input information, and other users can provide additional information related to the generated best practice report. The additional information can be incorporated in the best practice report, or the additional information can be stored as a separate report in best practice report database 112 and linked to the related best practice report already stored in the best practice database 112.

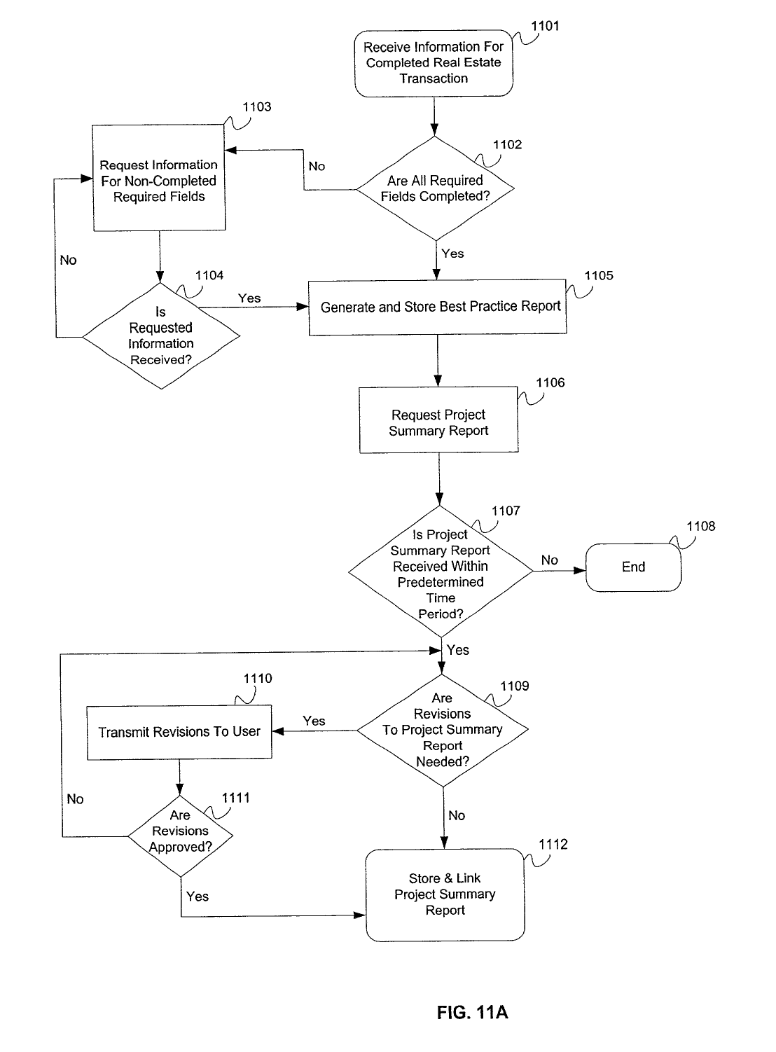

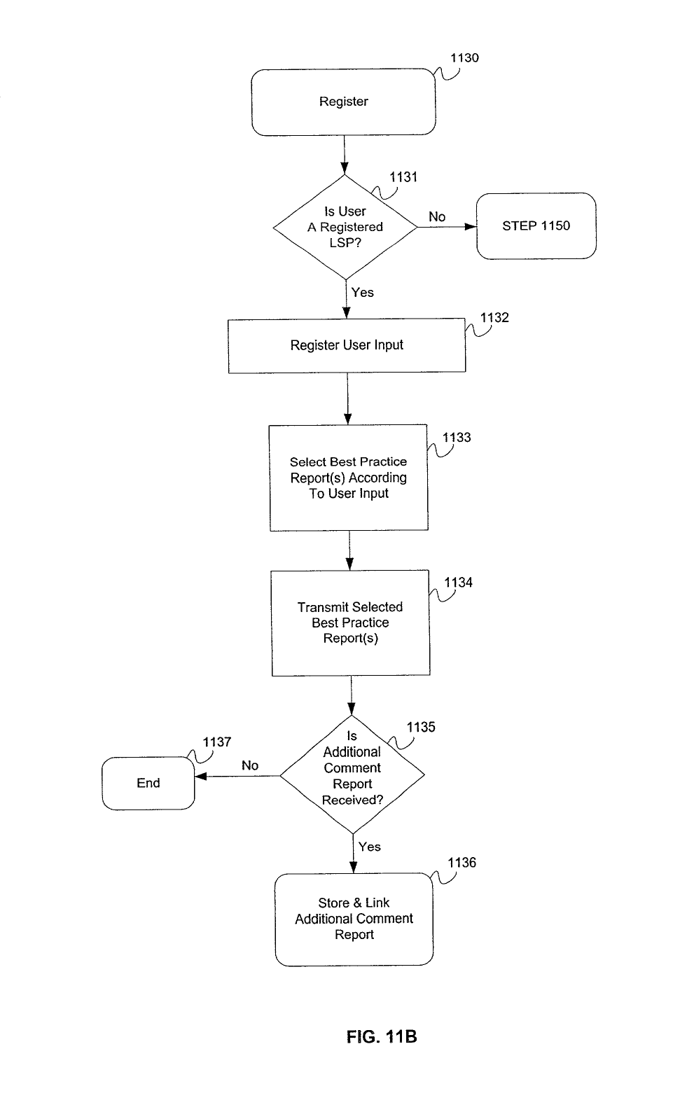

Structured transaction engine 103 controls access to best practice reports by displaying web pages requesting information for creating a query to retrieve best practice reports that are desired by the user. The query is used to retrieve best practice reports from best practice report database 112. Processes for generating and accessing best practice reports are described in detail below with respect to FIGS. 11A-C.

FIG. 1B shows a computer-implemented method for negotiating a lease transaction using structured negotiation phases. As shown generally in these figures, each party can independently log into a web-based transaction management system (e.g., computer 100 of FIG. 1A) and negotiate lease terms by selecting choices from transaction display screens. In one embodiment, parties are prevented from advancing to the next negotiation phase unless the computer detects that each user has either agreed to a specific lease term, or that each user has elected to defer agreement on a term until a later negotiation phase.

Each lease provision can be negotiated by taking one of several predefined actions. In one embodiment, at each top-level negotiation phase, a party must either AGREE or DEFER on each lease provision (e.g., by selecting a choice or clicking on an icon representing a choice). Each of these choices in turn can result in or derive from lower-level actions by involving lower-level decisions. In other words, before a party is prepared to AGREE or DEFER on a lease provision, lower-level decisions involving steps of mediation, issuance of third-party requests for assistance, or other types of actions may need to be taken. These lower-level decisions can be reached using additional computer screens that are linked to one or more of the higher-level screens.

More generally, the negotiation, execution and evaluation of a lease can be accomplished according to one aspect of the inventive principles using a reduced instruction protocol that facilitates and accelerates milestone decisions associated with the transaction. Such a protocol provides numerous benefits because, among other things:

(a) The lease transaction process is complex and can involve numerous participants and, in a cross-border context, these participants will most likely reside in different countries;

(b) There are varying degrees on skill among the representatives of the landlord and tenant and, in a cross-border context, varying levels of understanding of their respective roles and responsibilities;

(c) In a cross-border context, there are language problems, local knowledge gaps and cultural differences that can slow down negotiations;

(d) In a cross-border context, a computer application for this process functions best when it prescribes a clear set of top-level decisions (milestones) with a mechanism for coordinating the roles and actions of those who participate in reaching these decisions.

One embodiment of the protocol includes the following three elements, although other embodiments incorporate fewer than all three elements:

1. Decision Protocol

The parties must either agree or defer to all milestone decisions. This acknowledges that milestones are critical to completing the project, and that it is important to avoid the dead-end implied by using the word “no” (which is considered impolite or is non-existent in some cultures). The computer provides a facility for either agreeing or deferring on each milestone decision. In addition, displayed with each milestone decision is a dialogue box to enter a comment, or an icon to indicate that a comment has been entered and will be visible on another screen. Predefined actions in this category include:

Agree: a party acknowledges that a milestone decision has been reached (e.g., agreement on a specific monthly rent).

Defer: a party agrees to defer a milestone decision to a later date (e.g., defer a decision on the condition of the premises).

2. Resolution Protocol

Assuming that all milestone decisions must be agreed to complete the process, an additional mechanism can be used to convert deferrals into agreements. Therefore, the protocol provides three resolution mechanisms, including: (a) a user forum; (b) use of a LSP; or (c) mediation. The computer facilitates selection of LSPs or mediators (via menus of service providers, issuing scopes of services, etc.), and schedules meetings among the participants in these decisions. Three corresponding predefined actions in the resolution protocol category include:

Forum: the transaction parties (i.e., the landlord and tenant) meet in a structured environment (e.g., scheduled by computer) to agree on a milestone decision.

LSP: the parties agree to select a third party local service provider or providers (e.g., an architect) to facilitate reaching a milestone decision.

Mediate: the parties agree to select a neutral expert to facilitate reaching a milestone decision.

3. Action Protocol

The computer prescribes a sequence of milestone decisions to complete the process. For some milestones, additional work must be done to reach an agreement or deferral. The protocol streamlines this work into a prescribed set of actions that are required of the participants (i.e., the landlord, tenant, and LSPs), and which can be undertaken with computer assistance. The computer acts as an engine to provide adequate information and resources on the desktop of the landlord and tenant. Examples include distributing documents such as draft leases; issuing standardized documents such as Requests For Proposals (RFPs), specification of leasehold improvements, etc; notifying parties if any schedule dates have been missed or any input errors have occurred; and scheduling meetings among the participants.

In addition, the computer can prompt the participants about certain elements in the process. Examples include prompting the parties to identify resource persons; prompting the parties to negotiate certain aspects of tenant's physical environment; and prompting the parties to obtain signatures to certain documents.

It is anticipated that the computer can provide additional assistance in the more restricted roles by suggesting various courses of action. For example, if the parties had not resolved the delivery of the tenant's space on a “turnkey” basis, the computer could suggest that the parties agree to split the cost of the improvements above the landlord's “building standard” on a 50/50 basis. More generally, the computer can draw upon a library of potential solutions based on past practice to suggest resolution to certain milestone decisions or sub decisions. This facility could be visually displayed alongside any required future action. Examples of predefined actions in this action category include:

Identify: the computer prompts the parties to locate an appropriate internal resource person or entity. For example, prompt to identify authorized signatory for lease.

Issue: the computer issues a standardized document to the parties or to LSPs. For example, the computer can issue a request for proposals to one or more architects.

Notify: the computer sends a notice to the parties and/or LSPs if actions are erroneous or milestones are not completed by the scheduled dates. For example, the computer can notify the parties that a scheduled date for signature of lease has been missed.

Obtain: the computer prompts the parties to generate information from internal resources. For example, the computer can prompt the parties to obtain approvals for lease.

Provide: the computer prompts the parties as to generally submit information in support of a milestone decision. For example, the computer can prompt a party to submit a preliminary cost estimate for leasehold improvements.

Require: the computer can ask the parties whether they require standardized documents to assist in reaching milestone decisions. For example, the computer can ask the parties whether they require a broker RFP.

Receive: the computer receives and subsequently transmits in a summary form documents from third parties. For example, the computer can receive and transmit a response to a broker RFP.

Resolve: the computer prompts the parties or an LSP to reach agreement on detailed matters related to third party documents. For example, the computer can prompt parties to resolve outstanding provisions of lease agreement.

Schedule: the computer arranges meetings in a format chosen by parties and/or LSPs. For example, the computer can schedule a user forum to agree on outstanding lease issues.

Send: the computer transmits documents to parties. For example, the computer can transmit a draft lease to one of the parties or LSPs.

Select: the computer prompts the parties to make choices among alternatives provided on a screen or box. For example, a computer can prompt a party to select a mode for a user forum.

It will be appreciated that the above examples of predefined actions are exemplary only; different labels or actions can be specified, and each action can be selected using a pictographic icon or other means to facilitate communication across languages (e.g., a handshake icon to signify agreement on a lease provision).

In addition to selecting a pre-defined response such as one selected from the above choices, each party may also in certain circumstances enter ancillary information that is associated with and stored with the response. For example, if one party suggests a delivery date of October 1 for a leased property (and indicates AGREE for that date), the other party may instead suggest a delivery date of November 1 for the property. If both parties have selected AGREE but have entered different values, the computer would flag the discrepancy and possibly suggest a solution (e.g., split the difference). Alternatively, a single text entry box could be provided, and each party could override the other's entry, with the computer flagging any overridden value (and, in one embodiment, changing the first party's AGREE choice back to a default value or some other choice).

If both parties select the same response (e.g., one of the responses selected from the above list), then the agreed status of the particular lease term is deemed to be “locked in” and not subject to further negotiation. This is intended to facilitate the negotiation status by preventing parties from “back-tracking” to items that were previously the subject of agreement. However, the invention is not limited in this respect, and certain variations of the invention include allowing users to change previously matched responses.

Beginning in step 120 of FIG. 1B, the parties independently log into the system (e.g., using a user name and password). A user can include a party to the negotiation (e.g., a landlord or tenant), although it could also include agents or others acting on behalf of principals to the negotiation. In step 121, if a user is not recognized, then in step 122, user registration information (e.g., name, address, e-mail address, and the like) is obtained. In step 123, a check is made to determine whether the user seeks to negotiate a new lease or continue negotiating a previously started lease.

If a new lease is selected, then in step 124 a new negotiation file is established, and each user can select options such as the currency to use for displaying negotiation information and metrics (e.g., square feet or square meters). In one variation, a prospective tenant and landlord can choose to view the information in different formats, such that the tenant views the rent in dollars and the landlord views the rent in Euros, for example. Currency and metrics converters (function 109 in FIG. 1A) are used to automatically convert between units entered by the users based on currency exchange rates. In another variation, values are shown simultaneously in two formats (e.g., square meters and square feet), and the parties can select what formats are to be displayed (e.g., dollars and Euros simultaneously, or dollars and French francs simultaneously). It is assumed that currency exchange information is stored in a database or accessible over a network such as the Internet.

If negotiations regarding a previously started lease are to be resumed, then in step 125 computer 100 retrieves previously stored negotiation information from database 104. In step 126, each user (i.e., each tenant and landlord) selects a negotiation phase and enters choices for decisions to be reached during each phase. According to the invention, each party can log on independently and at different times to negotiate the lease, so that it is not necessary to have simultaneous participation by the parties. Of course, it is possible that the parties might log in at overlapping times, and in such a case the system can prevent both users from modifying the same data at the same time (e.g., using file or database locks, for example).

Step 126 can involve subsidiary steps of negotiating particular aspects of a lease provision before agreement or deferral on the provision is reached. For example, before a party is prepared to agree to a lease provision defining the condition of the premises, several sub-decisions may be involved, such as determining what types of electrical systems will be provided, what type of security'system is included, etc. These provisions can be negotiated using lower-level computer screens that invite the user to make selections based on pre-defined choices. In one embodiment, the computer indicates to the user that sub-decisions are involved, and prompts the parties to ensure that such sub-decisions are addressed. Alternatively, if the tenant has for example agreed to take the premises in “as-is” condition, these lower-level decisions will be unnecessary, and the computer can avoid prompting the tenant for these choices.

If in step 127 a user specifies that he or she is done entering information, then processing advances to step 129. At various points during the process, each user may optionally choose to generate one or more intermediate documents (e.g., a draft lease proposal or the like) depending on the negotiation phase in which the user is participating (see step 128). Further details of this optional step are provided below.

In step 129 the computer checks to determine whether all of the choices selected by the user in the negotiation phase are either AGREE or DEFER. If so, then in step 130 another check is made to determine whether the other party has also selected choices for the particular negotiation phase. If not, then in step 133 an e-mail message or other notification is transmitted to the other party inviting that party to review the responses provided by the first user. If further explanation is required, the computer can provide a summary of the phase with some frequently asked questions. Additionally, the computer can provide a comment or dialog box for each phase to facilitate direct communication between the parties. Processing then either terminates or returns to a previous step (e.g., step 125 of FIG. 1B).

If in step 130 the other party to the negotiation has also selected choices for the particular negotiation phase, then in step 131 a check is made to determine whether all of the choices specified by the other party are either AGREE or DEFER. If not, then in step 134 an error message is generated and solutions are suggested. For example, if one party has selected AGREE for a particular lease provision but the other party has selected DEFER, the computer can suggest that the agreeing party DEFER the decision until the next negotiation phase. As another example, if one party has agreed to $5,000 per month rent but the other party has agreed to $6,000 per month rent, the computer can flag the discrepancy and suggest a compromise rent of $5,500 per month.

Alternatively, a single text box can be provided for entering a value such as rent, thus allowing each party to override the other's value. In one variation, the computer would then change the choice of the party whose value was overridden from AGREE to undecided or some other choice and generate a message indicating that the first party had changed the value. In yet another embodiment, if the two parties had agreed on different amounts, the computer would change both AGREE choices to DEFER, such that the decision would be deferred to a later negotiation phase.

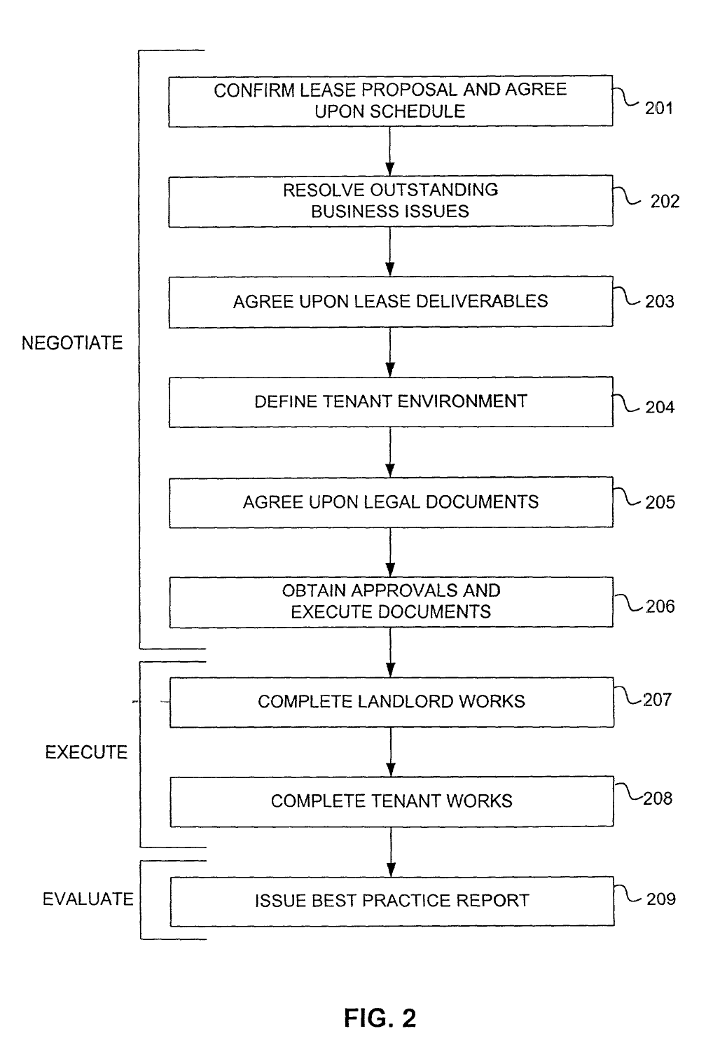

If in step 131 both parties have selected either AGREE or DEFER for all lease terms pertaining to the particular negotiation phase, then in step 132 the agreed terms are deemed “locked in” by the computer and not subject to further change; all those for which the parties have indicated DEFER are deferred by the computer until a later negotiation phase. Thereafter, in step 135 the user is permitted to advance to the next negotiation phase (e.g., one of the nine negotiation phases shown in FIG. 2). The previous steps beginning at step 126 are then repeated for each phase until the negotiation has been concluded.

Assuming in step 129 that the user did not choose either AGREE or DEFER for each item in the negotiation phase, then an error message is generated, and processing returns to step 126. It will be appreciated that options other than AGREE or DEFER can be provided without departing from the scope of the invention. Moreover, graphical icons (e.g., a handshake symbol instead of an AGREE choice) can be used. Choices can also be shown in different languages to the different parties, such that one party to the transaction sees choices in English while the other party to the negotiation sees the same choices in Spanish, for example.

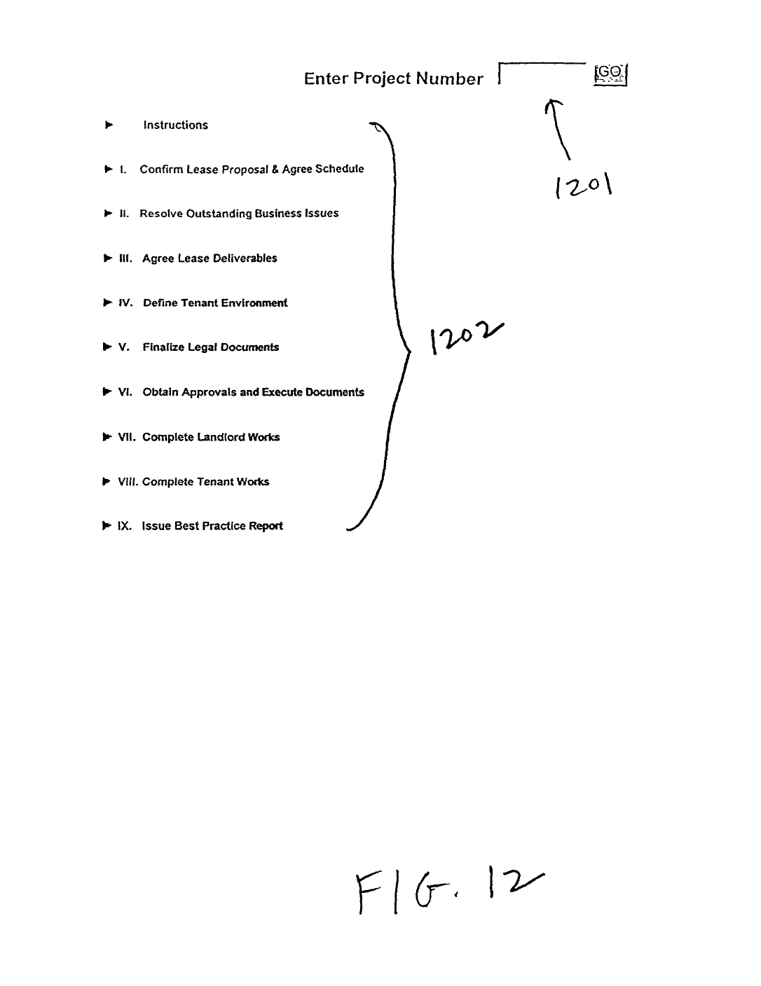

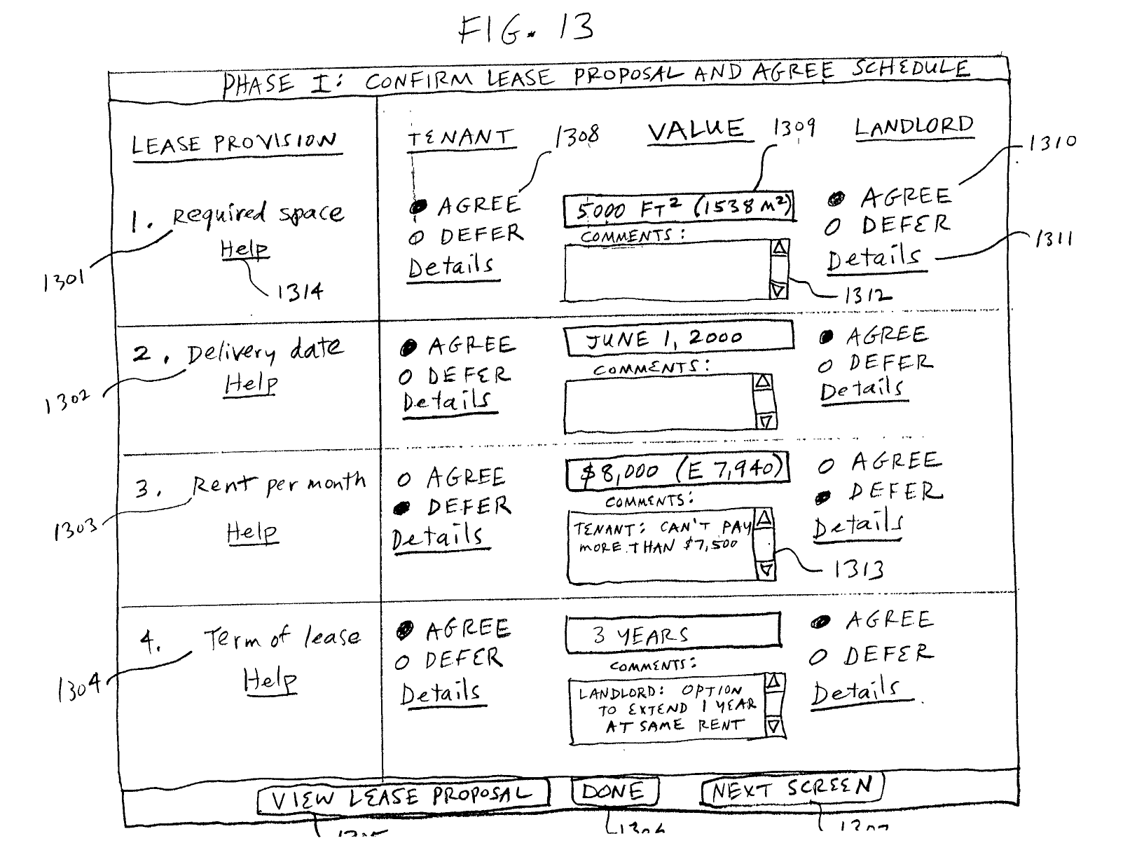

FIG. 2 shows a generalized nine phase computer-assisted process for negotiating, executing, and evaluating a lease transaction according to one variation of the invention. As explained above, in one embodiment each party is required to select agreement or deferral of certain lease provisions before the computer will allow the users to advance to the next negotiation phase. Selection of other choices for lease provisions within a negotiation phase may require ancillary communication (e.g., transmission of requests for services) or processing (e.g., submission of information). Web-based computer forms, such as those shown in FIGS. 13 through 15, can be used to select choices relating to lease provisions. Certain phases (e.g., 201 through 206) generally relate to the negotiation of a lease; other phases (e.g., 207 and 208) relate to execution of the lease, and a final phase (209) relates to evaluation of the completed lease transaction.

As shown in FIG. 2, a first phase 201 includes steps of confirming a lease proposal and obtaining agreement upon a lease schedule (e.g., delivery date). This phase is preferably conducted through the use of web-based computer display forms having appropriate selection means (e.g., radio buttons, check boxes, text boxes, pull-down menus and the like) that allow each user to enter and view information for the particular phase. Further details of one possible embodiment are provided below.

A second phase 202 includes steps of resolving outstanding business issues, wherein users are presented with a checklist of outstanding issues deferred from the first phase and prompted to develop solutions to these issues. A third phase 203 includes steps of obtaining agreement on lease deliverables (e.g., condition of the premises, furnishings, telecommunication systems, etc.). A fourth phase 204 relates to defining the tenant environment (e.g., preliminary floor plans, furniture, etc.). In this phase, the tenant defines his or her requirements to occupy the premises, including improvements and investments not provided by the landlord (which are typically included in the third phase). In the fourth phase, the landlord may or may not be involved in decisions regarding specification of furniture, network, and telecommunication systems, for example.

A fifth phase 205 relates to agreement on legal documents, including a step of generating a draft contract. A sixth phase 206 relates to obtaining approvals and execution of the lease documents, including steps of submitting forms for corporate approvals, paying deposits, etc. A seventh phase 207 relates to completing landlord works (e.g., landlord delivers landlord-supplied network system and leasehold improvements). An eighth phase 208 (completion of tenant works) includes steps such as delivering tenant-supplied furniture and telecommunications systems. This may include the use of contractors such as architects and engineers, and may or may not involve the landlord.

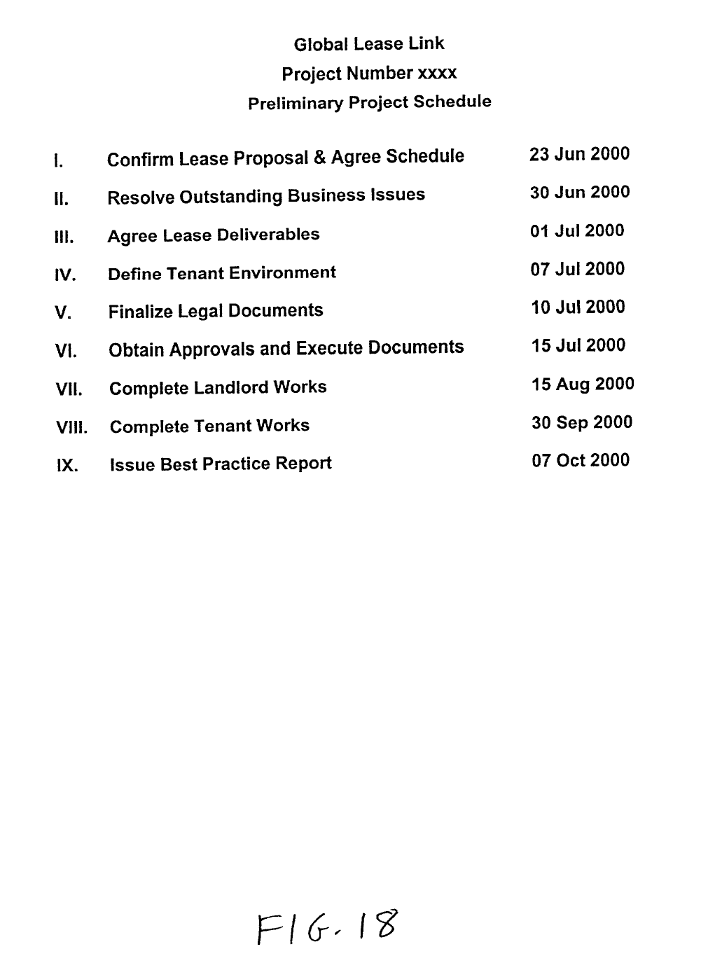

In the seventh and eighth phases, it is generally contemplated that the computer will perform a monitoring function of the scheduled dates for delivery of works as anticipated in the schedule, with a communication function in the event that scheduled dates are missed and a function to issue a standardized form for acceptance of works performed by the landlord and/or LSP's. Turning briefly to FIG. 18, a computer-generated schedule incorporating the major milestone phases is shown. In one embodiment, the computer generates such a schedule by using the lease move-in date as a starting point and “backing out” dates for earlier milestones using either default values or values retrieved from a database based on historically experienced lease transactions. As each date is reached, the computer can prompt the parties to agree that a particular phase has been completed, and can transmit a message to each party warning of upcoming delays if the phase is not completed. Although most milestones can be assumed to have a linear dependency (e.g., legal documents cannot be finalized until the lease proposal is agreed), it is also possible that certain milestone decisions can be deferred until later phases, such that a schedule slip in one milestone does not necessarily result in slippage for all remaining milestone decisions.

A final ninth phase (issue best practice report) includes steps of evaluating local service providers and preparing a best practice report, which is preferably stored in a database for future reference.

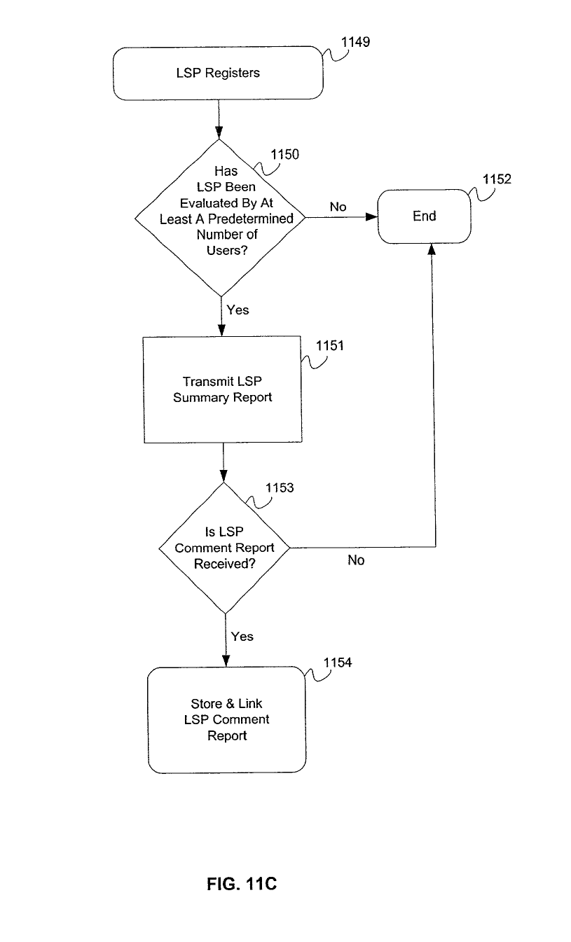

The following description, in conjunction with FIGS. 3 through 11 (details of each negotiation phase) and FIGS. 12 through 15 (computer-implemented forms that solicit information for each phase), explains one possible approach for implementing a method and system according to the present invention. It will be assumed that prior to performing the steps shown in FIG. 3, a user has logged into the system and, if pertinent, reviewed e-mail messages in his/her account that were received from other users, such as another party to the negotiation. It will also be assumed that a web-based computer display system using well-known hyperlink technology is used to solicit mad display information between parties, although the invention is not limited in this respect.

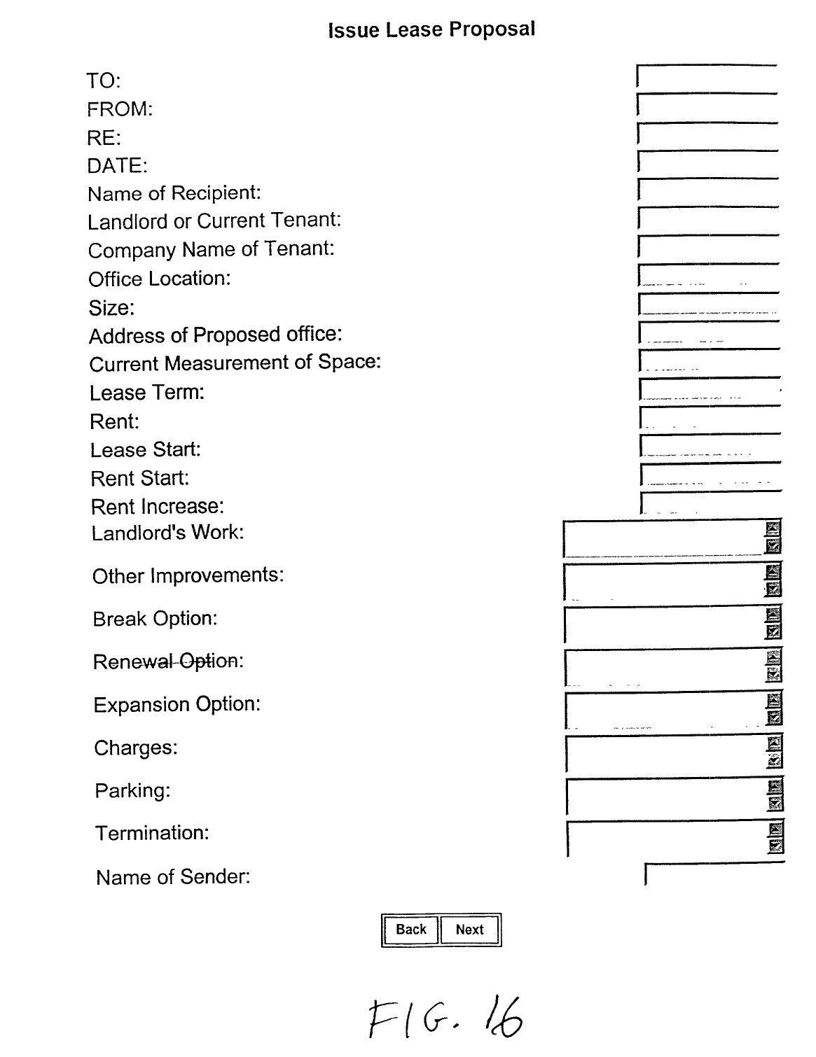

Turning first to FIG. 12, a top-level project negotiation phase selection page is presented to the user after the user logs in and identifies himself or herself. If a user is beginning a new negotiation, then a separate computer screen (not shown) is displayed to solicit information concerning the parties and the subject of the negotiation. Otherwise, if a previous negotiation has already been started, the user can enter the project number or name into a text box 1201 and the system will retrieve previously stored information regarding the lease. A top-level selection list 1202 contains hyperlinks to web pages corresponding to each of the nine negotiation phases identified on FIG. 12 (and also identified in FIG. 2) and would highlight the current phase that is in negotiation. As an alternative to the hyperlinked display screens described below, each party can fill out a “short form” lease proposal of a type shown in FIG. 16, and the computer can identify any differences between the choices selected by the two parties and focus on those areas of disagreement.

Although the user can jump directly to any negotiation phase, it is contemplated that each user will progress sequentially through the phases, and that users will be prevented from jumping ahead to later phases until agreement has been reached on lease provisions in each phase. Assuming that the user has not previously negotiated any of the lease provisions, the user would click on the first phase (Confirm Lease Proposal and Agree Schedule), which would cause the computer to display a screen such as the one shown in FIG. 13.

FIG. 13 shows a web-based computer screen in which a tenant and landlord select predefined choices for lease provisions according to a first negotiation phase. This figure will be explained with reference to FIG. 3, which shows computer-implemented steps that can be used to negotiate between parties during a first phase of a lease negotiation. The steps need not be executed in sequential order as illustrated in FIG. 3. For the sake of simplicity, only four lease provisions are shown in FIG. 13 even though FIG. 3 shows 9 separate provisions. It should be understood that the illustrated lease provisions are by no means exhaustive or exclusive.

In general, for each negotiation phase the parties are presented with a set of provisions related to the lease or leased premises, and a set of choices (e.g., AGREE or DEFER) for taking action on each provision. For certain lease provisions, the parties must not only indicate agreement, but must agree on a specific value or values (e.g., the amount of rent to be charged). In some cases, agreement cannot be reached without negotiating lower-level details. In those cases, the computer-implemented method permits the parties to jump to the lower-level decision making process before committing to an AGREE or DEFER at the higher level of the negotiation phase. Where a lease provision is deferred, the provision can be negotiated during a later phase by selecting choices other than AGREE or DEFER (e.g., resolution protocol actions such as user forum, LSP, or mediation).

As shown in steps 301 through 309 of FIG. 3, each party is asked to agree upon certain lease provisions (and, where appropriate, to specify certain information such as rental price). Although these steps are shown as sequential in FIG. 3, each user could of course select the choices and enter information in an order different from that shown. In one embodiment, however, a user is prevented from advancing to the next phase of negotiation until all provisions are either agreed to by both parties or any areas of disagreement are indicated as being deferred.

As shown in FIG. 13, four different lease provisions 1301 through 1304 are arranged on the left side of the computer screen. A HELP linkage 1314 can be provided for each lease provision to explain common lease provisions and to answer frequently asked questions. The right side of the screen in FIG. 13 is divided into a tenant portion, a landlord portion, and a middle portion in which either party can enter information. In general, it is anticipated that when the tenant logs into the system, the tenant will only be able to select or modify choices listed under TENANT and values in the middle portion of the screen. Conversely, the landlord can only select or modify choices listed under LANDLORD and the values in the middle portion of the screen. Each party specifies one, or more values in the middle portion of the screen, optionally indicates comments in one or more comment boxes 1312, and clicks a DONE button 1306 to signify that they have completed their responses for each negotiation phase.

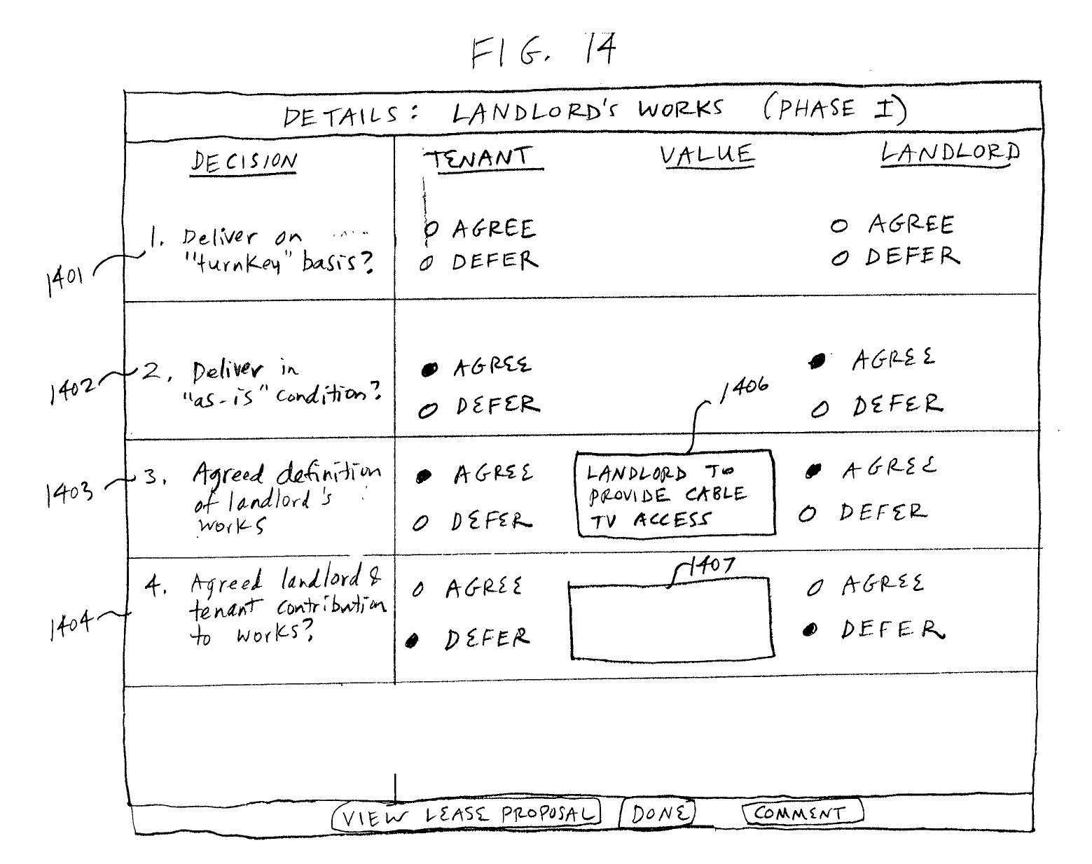

In general, each tenant and landlord must select either AGREE or DEFER for each lease provision. Before selecting a choice for a particular lease provision, the party can “drill down” to a lower-level decision making process by clicking on an associated DETAILS hyperlink 1311, which would bring up a page such as that shown in FIG. 14. Suppose, as shown in FIG. 13, that both parties have agreed to a required space provision of 5000 square feet (automatically converted into square meters by the computer); a delivery date of Jun. 1, 2000; and a lease term of 3 years. Suppose further that the parties have agreed to defer agreement on the amount of rent (although a proposed rent amount is listed, and the tenant has added a comment to comment box 1313). As to the landlord's works (not explicitly shown in FIG. 13), the parties do not have enough information to agree or defer to the next step. In that case, one or both of the parties could click on the associated DETAILS link, which would bring up the screen shown in FIG. 14.

Turning to FIG. 14, the parties are presented with a set of lower-level decisions concerning the landlord's works lease provision. As shown in FIG. 14, agreement on a landlord's works includes deciding whether the premises are to be delivered on a “turnkey” basis 1401; “as-is” condition 1402; a definition of the landlord's works 1403; and agreement on the landlord's and tenant's contribution to the work 1404. A help button (not shown) can be included to explain the decision and provide a reference to local market practice in a particular city.

Some of these sub-provisions require nothing more than an AGREE or DEFER decision (e.g., 1401 and 1402), while others (e.g., 1403 and 1404) require that a value be provided by one or the other party (e.g., elements 1406 and 1407). Each party can select choices as shown in FIG. 14 before selecting DONE and returning to the top-level lease provision screen shown in FIG. 13.

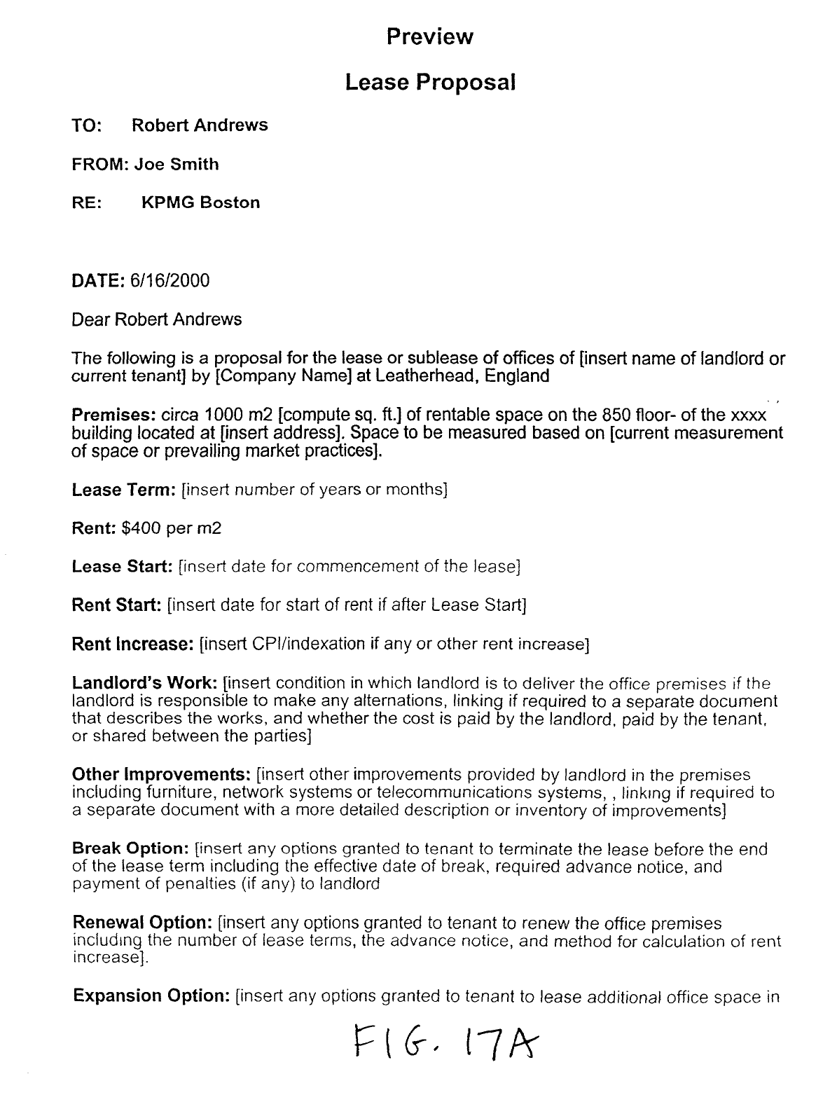

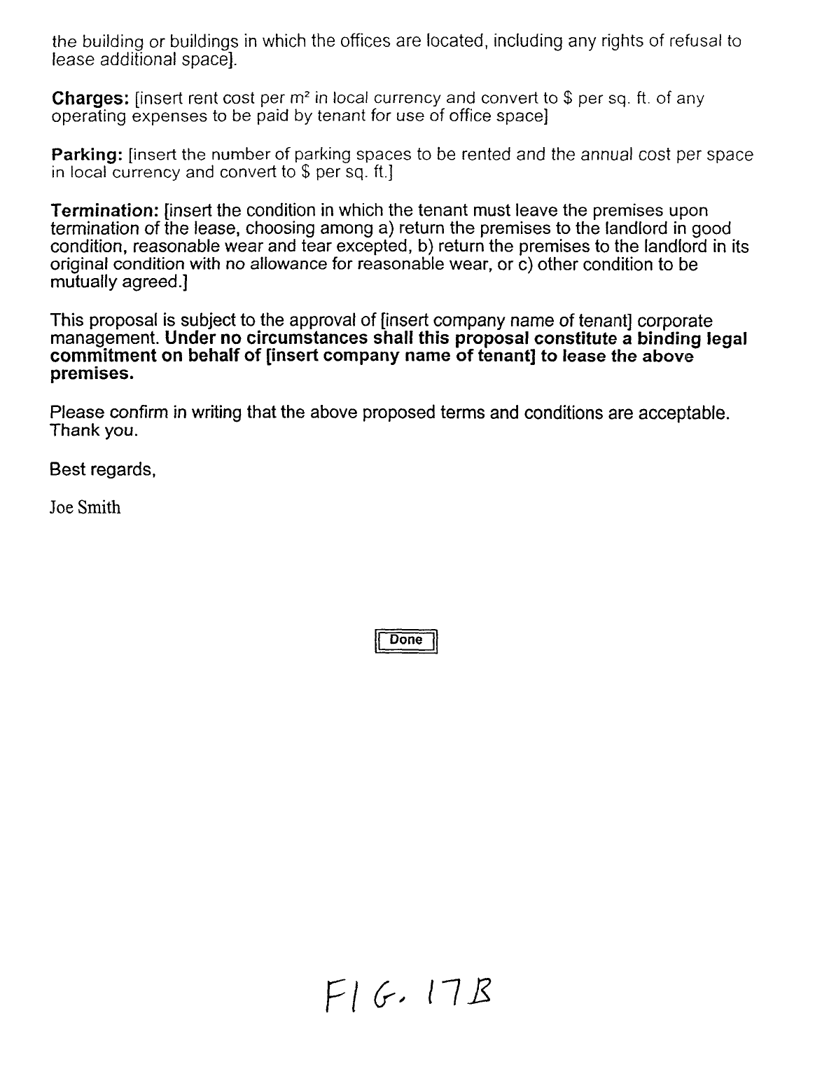

During the negotiation phases, either party can choose to view a draft lease proposal by clicking on VIEW LEASE PROPOSAL button 1305. In response, the computer generates a draft lease proposal incorporating the lease provisions that had so far been agreed to by the parties. One example of this is shown in FIGS. 17A and 17B. As a practical matter, after the lease has been negotiated (e.g., step 206 of FIG. 2), the lease proposal would be superseded by the actual lease.

As shown by the steps in FIG. 3, additional lease provisions including lease term, tenure, landlord works (e.g., “as is” condition or “turnkey” basis), other improvements, other conditions (e.g., parking, operating expenses, termination condition, etc.), and draft schedule can also be agreed to, deferred, or negotiated using the above-described process.

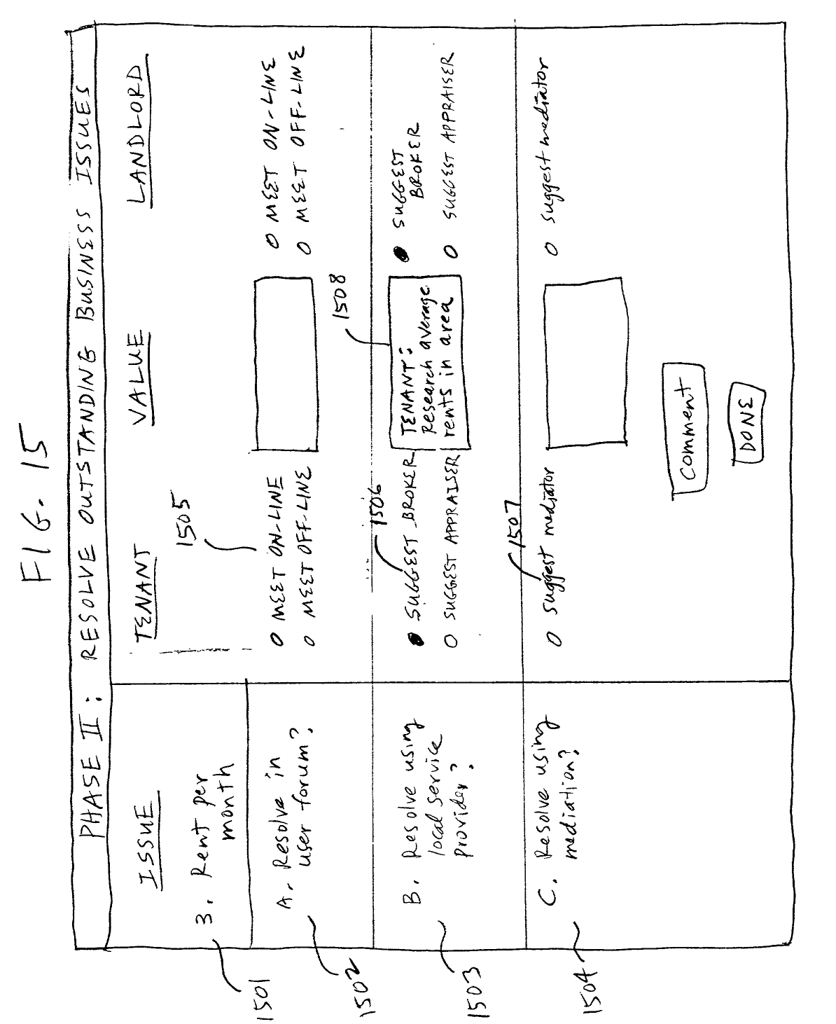

Assuming that both parties have selected either AGREE or DEFER for each lease provision and click DONE, the computer will advance to the next negotiation phase, which will now be explained with reference to FIG. 15. If the parties have not selected either AGREE or DEFER for all lease provisions in the first negotiation phase, then in one variant of the invention they will be prevented from advancing to a later negotiation phase. In certain variations of the invention, however, the parties are allowed to defer lease provisions such as the condition of the premises until successively later phases; at each later phase, the parties are prompted to resolve any outstanding issues.

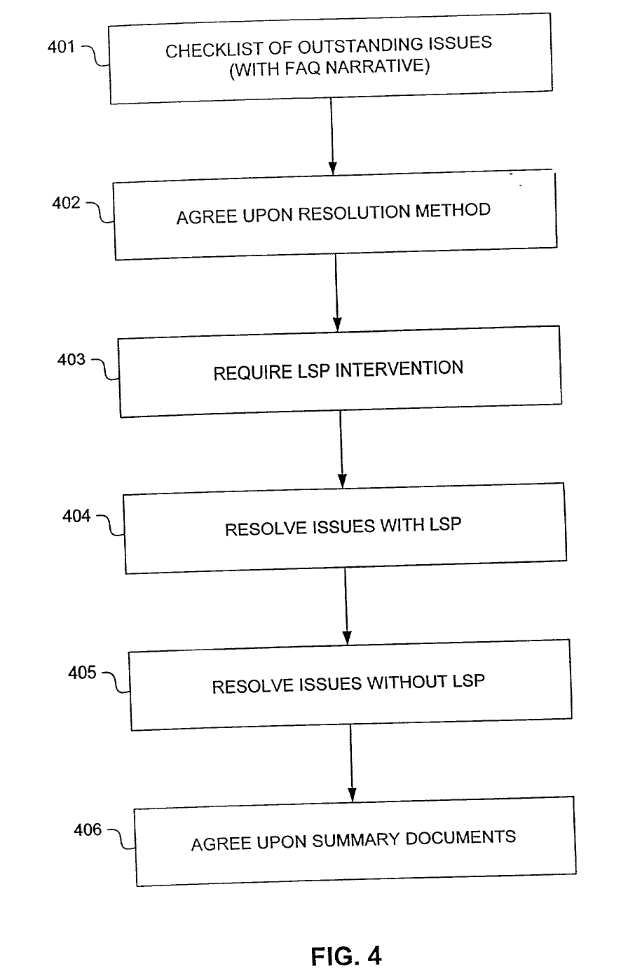

FIG. 15 shows a computer screen with choices for a second negotiation phase. As shown in FIG. 4, in one variation of the invention the second phase includes steps of presenting a checklist of outstanding issues that were deferred from the first phase, and soliciting inputs from the parties that will allow the parties to reach agreement on the deferred issues using, for example, a local service provider (LSP) or mediator. Because the amount of the rent was deferred from phase one (see FIG. 13, lease provision 1303), this lease provision is again presented to the parties (item 1501 in FIG. 15) with options for resolving the issue. In one variation of the invention, an issue can be resolved directly by the parties, or by involving a third party. The parties may choose for example to resolve the rent issue in a user forum 1502, such as an on-line or off-line meeting (choices 1505). If both parties agreed to such a resolution, the computer would assist in arranging an on-line or off-line meeting (e.g., by asking the parties for available times; accounting for time zone differences, etc). The computer could arrange a chat-room dialog in an on-line forum or a conference call using a computer-aided program and may include a link through another web site.

Alternatively, the parties may choose to resolve the issue using a local service provider 1503. Two examples of local service providers relevant to the issue of rent might be a real estate broker in the area of the leased property or an appraiser. As indicated in FIG. 15, the parties may agree to hire a broker (choice 1506), and the computer could suggest a broker in the geographic area of the leased property. The parties may further choose whether to hire a separate broker, or to jointly hire a broker to advise both parties as to local practice (not explicitly shown). As indicated in comment box 1508, the tenant has suggested that the broker should research average rents in the leased area to help resolve the issue (see below).

As yet a third option, the parties may agree to resolve the issue through the use of a mediator 1507. In that case, the computer can again suggest one or more mediators familiar with the type of lease transaction and convenient to one or both of the parties. Additional computer screens (not shown) can be presented to the user to obtain information necessary to consummate the third party relationship. The computer would issue a request for proposals for the required assistance.

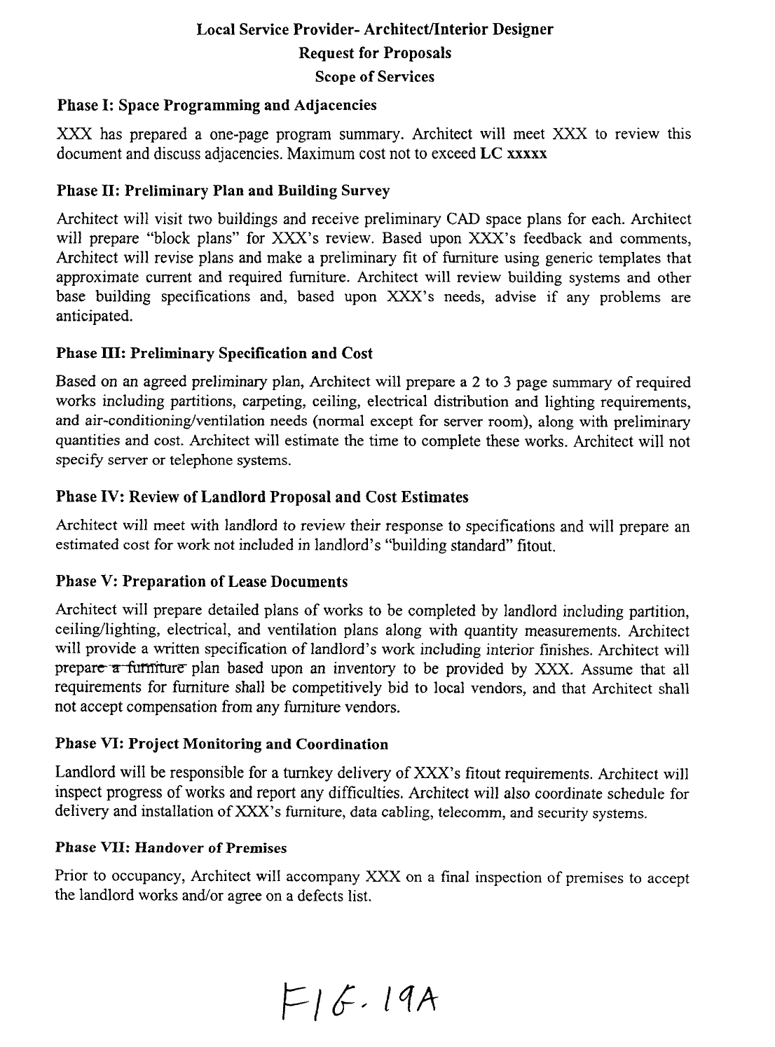

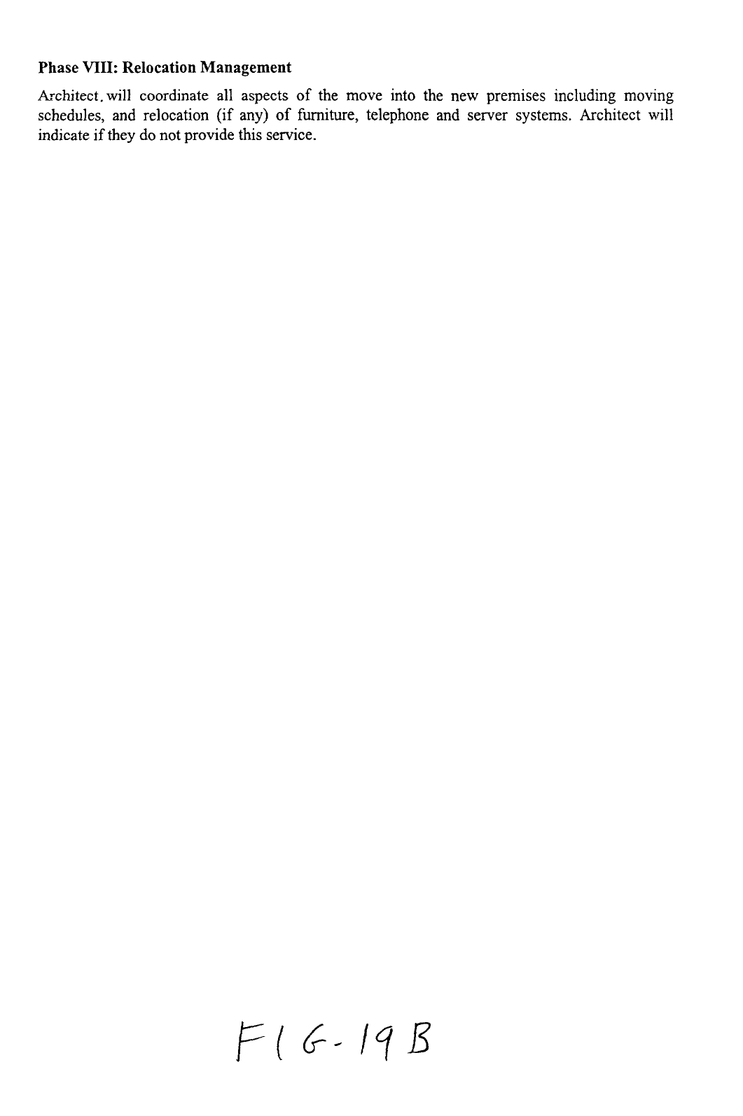

The negotiation options presented by the computer can be tailored to the specific lease provision that is the subject of dispute. For example, if the parties are stuck on the subject of the condition of the leased property (e.g., the type of network communication system that will be provided), the computer would suggest a service provider familiar with telecommunication systems, such as an engineering consultant or a company that specializes in providing networks. As another example, if the parties have not reached agreement on a floor plan, the parties could enlist the services of an architect or interior designer, again with computer-generated requests for proposals with the required scope of services (see, e.g., FIGS. 19A and 19B).

If the parties agree that a local service provider is to be hired, the computer system can recommend one or more providers based on the geographic area of the lease (see FIG. 1, vendor database 106). Alternatively, a party may individually choose to hire a local service provider without the assent of the other party (e.g., an architect), and the system can recommend one or more service providers in the same manner. In one embodiment, the system generates a preformatted request for services using information obtained during the negotiations (e.g., name/address of the tenant, information concerning the leased space, etc.) and transmits the request to one or more vendors in order to receive a quote for services. The request can be transmitted via e-mail or fax by the computer system, and each vendor can submit a bid or response to the party or parties requesting the services. The computer can receive responses in a standardized format and transmit to the parties a comparison of the proposals if more than one vendor were selected. In one variation, vendor database 106 includes information concerning ratings or quality marks for specific vendors based on prior experience with other parties. Consequently, the parties can make an informed decision regarding potential third-party service providers.

Resolving issues using an LSP can be done through on-line web-based conference calls, email, telephone calls, and/or in-person meetings. Resolving issues without the use of an LSP can be done using the same techniques.

After the issues are resolved by the parties, the parties enter the resolved information into the computer (using, for example, the computer form of the type shown in FIG. 13) and the computer stores the revised negotiation information into the lease database. Additionally, the computer can “lock in” the agreed items to prevent modification by either party. The result of phase two is a revised lease proposal with the agreed changes, which the computer generates upon command based on the revised negotiation information.

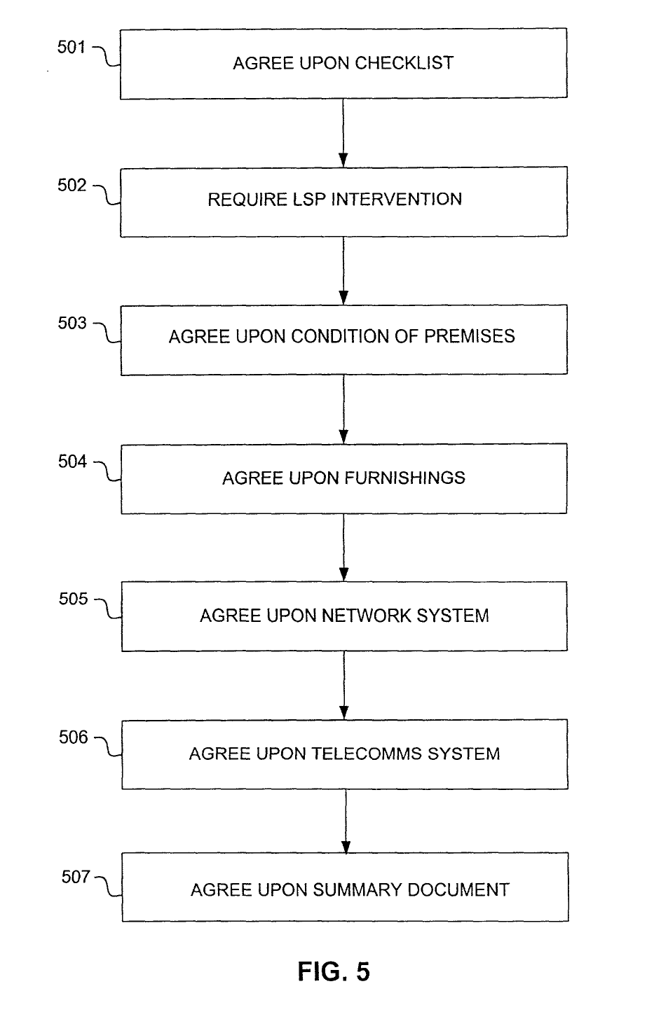

Once the parties have successfully completed the first and second phases of the negotiation, the computer system will allow them to proceed to the third negotiation phase. It should be understood that additional computer screens corresponding to the steps in FIG. 5 and the succeeding negotiation phases can be provided, although none are illustrated herein.

The third negotiation phase (agreement on lease deliverables) will be described with reference to FIG. 5. It will be appreciated that although some of the steps shown in FIGS. 5 through 11 appear to repeat some of the lease provisions that were the subject of an earlier negotiation phase, in practical terms any lease provision that was the subject of complete agreement in an earlier phase would be removed from later negotiation phases.

Beginning with FIG. 5, in step 501 the parties agree upon a checklist (e.g., condition of the premises, furnishings, network systems, etc.). If these were already agreed to in an earlier negotiation phase, the computer would delete them from a later phase. In step 502, the parties agree upon the condition of the premises, indicating whether the premises will be delivered “as is,” or with turnkey modifications or with other modifications. In step 503, if LSP intervention is needed, it is selected as described above. In step 504, the parties agree upon the furnishings (e.g., cafeteria equipment, furniture, etc.). In step 505, the parties agree upon a network system, and in step 506 they agree on a telecommunications system (using if necessary an LSP as per step 503). In step 507, the parties agree upon a summary document including the agreed deliverables and a completed lease proposal including schedule.

In one variation of the invention, a schedule calculator (FIG. 1A, element 111) calculates a proposed schedule corresponding to milestones during the negotiation and execution phase, based on average actual lengths of time stored in a database. In one variation, the lengths of time stored in the database are based on or derived from previously negotiated contracts (i.e., real-world practice is used to project future schedules). For example, if over the course of five different negotiated leases the average amount of time needed to go from generating a draft lease to moving into the leased property is two months, the scheduler would use that value to schedule such a milestone two months before the lease move-in date. The computer displays and prints a lease negotiation and execution schedule based on information provided by the parties and from databases of previously negotiated leases. FIG. 18 shows a computer-generated schedule for each phase of a nine-phase lease negotiation and execution process.

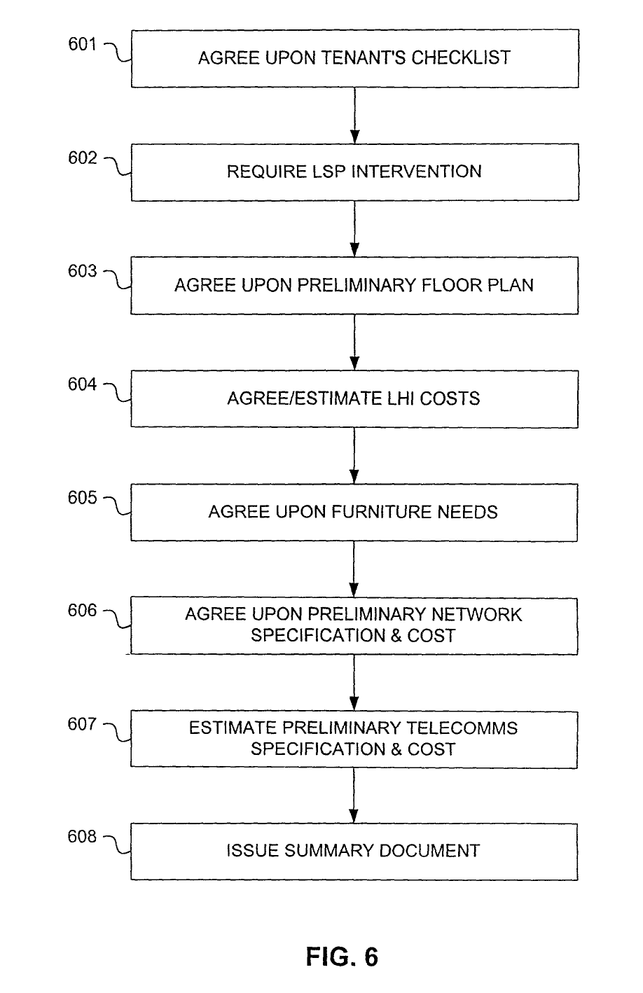

The fourth phase (define tenant environment) will be explained with reference to FIG. 6. In step 601, the parties (including the tenant and its local service providers) agree upon a tenant's checklist. This can include an agreement on a floor plan, furniture needs and costs, and LHI (leasehold improvement) cost. Steps 602 through 607 are similar in nature to the other steps already discussed (i.e., the parties either agree or defer agreement on each item, and can resolve areas of disagreement using LSP's or other options). The result of negotiation in phase four is the issuance of a summary document including a checklist of outstanding tenant environment needs; a modified lease proposal; and a revised schedule (if necessary).

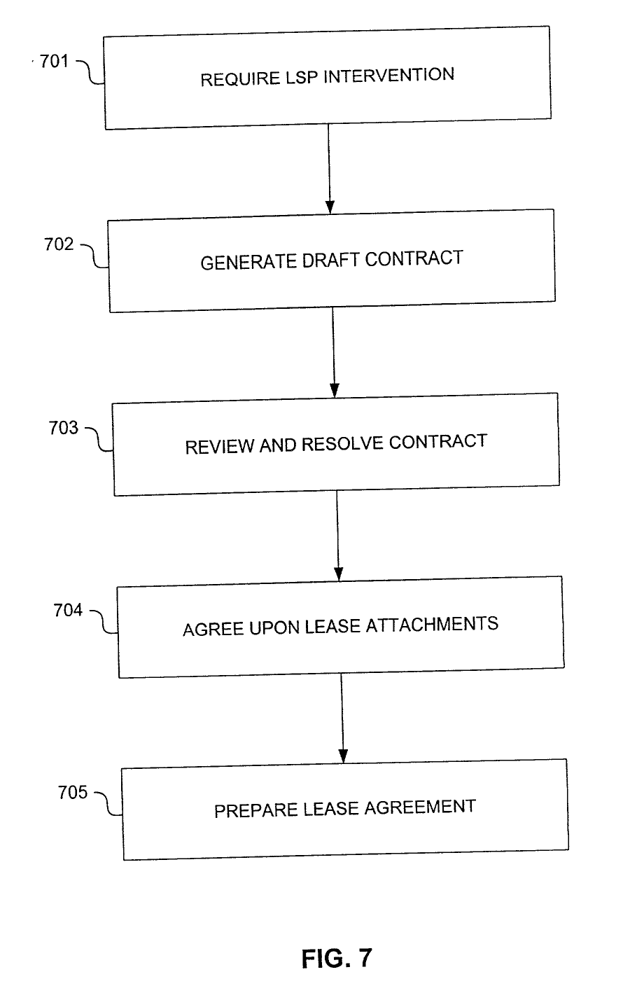

The fifth phase (agreement on legal documents) will be described with reference to FIG. 7. In step 701, the parties agree to require intervention by LSPs (e.g., lawyers) if necessary. In step 702, a draft contract (lease) is generated by the computer on the basis of the negotiated information that was “locked in” by agreement of the parties. This step can be done using a document template populated with information from lease database 104. In step 703, the parties review and resolve the contract, including mediation if necessary. In step 704, the parties agree upon lease attachments such as a detailed description of office space, final plans and specifications. In step 705, a lease agreement is prepared. The result of the fifth phase is a lease that the parties agree on (but which has not yet been executed).

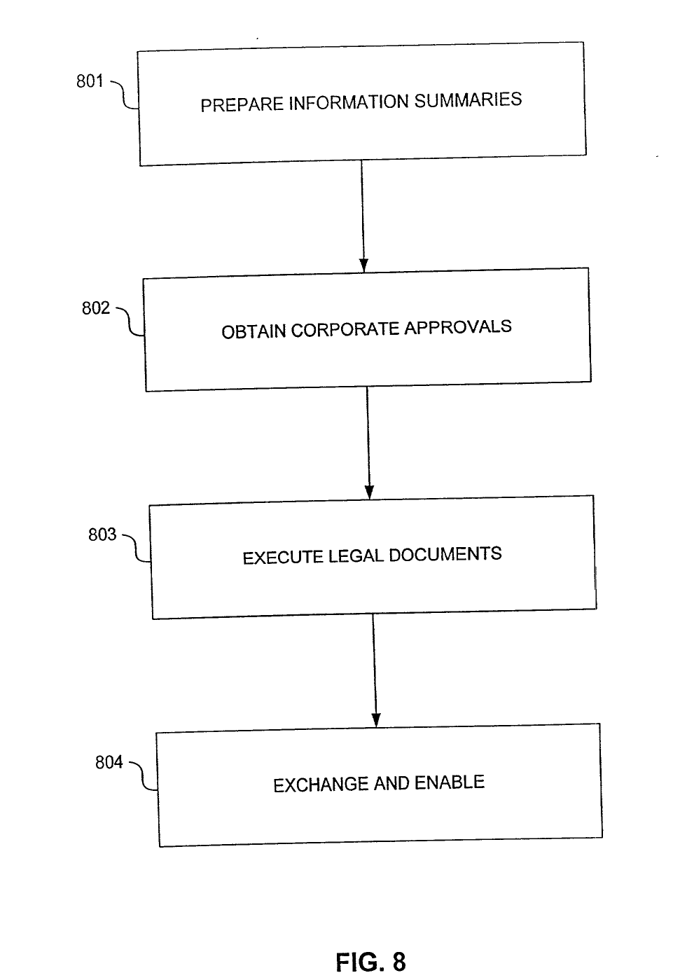

The sixth phase (obtain approvals and execute documents) will be explained with reference to FIG. 8. In step 801, information summaries are prepared. If a corporate approval summary is required, a standard corporate approvals form is generated using information from the lease database. If a financial analysis is required, a standard financial analysis form is generated. In step 802, corporate approvals are obtained by each party. This includes steps of submitting the forms and information for internal approvals, obtaining signatures of local subsidiaries if required; and obtaining management signatures on the approval forms. In step 803, the legal documents are executed. This may include steps of identifying authorized signatories; transmitting original signature documents by e-mail, fax or express mail, and obtaining the actual signatures. In step 804, the parties exchange documents, pay required deposits, and exchange keys or other entrance mechanisms (security codes, etc.) The outcome of this phase is that all legal documents are executed and access is granted to the premises.

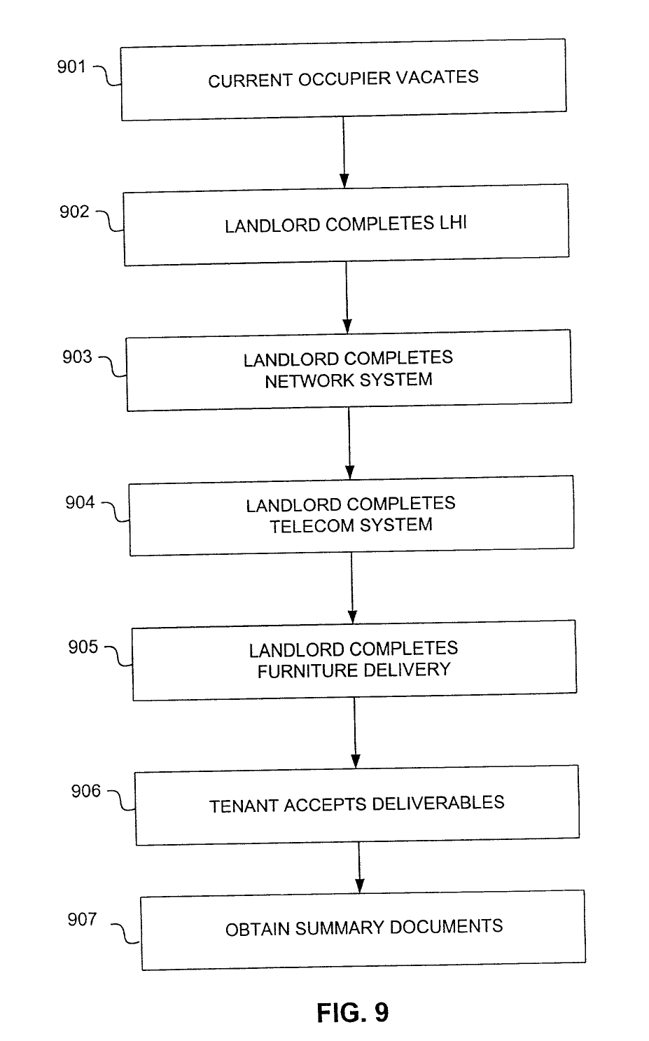

The seventh phase (complete lease deliverables) will be explained with reference to FIG. 9. In step 901, the current occupier vacates the premises (if it has not already done so). In step 902, the landlord completes the leasehold investment required under the lease. In steps 903 and 904, the network and telecommunication systems are delivered in accordance with the lease. In step 905, the furniture is delivered and accepted. Any works for which the landlord is not responsible would be eliminated as decisions in this phase.

In step 906, the tenant formally accepts all of the above deliverables (to the extent that these were not accepted in the preceding steps); this may include steps of inspecting the premises, rectifying defects or variances, and providing a summary of delivered items.

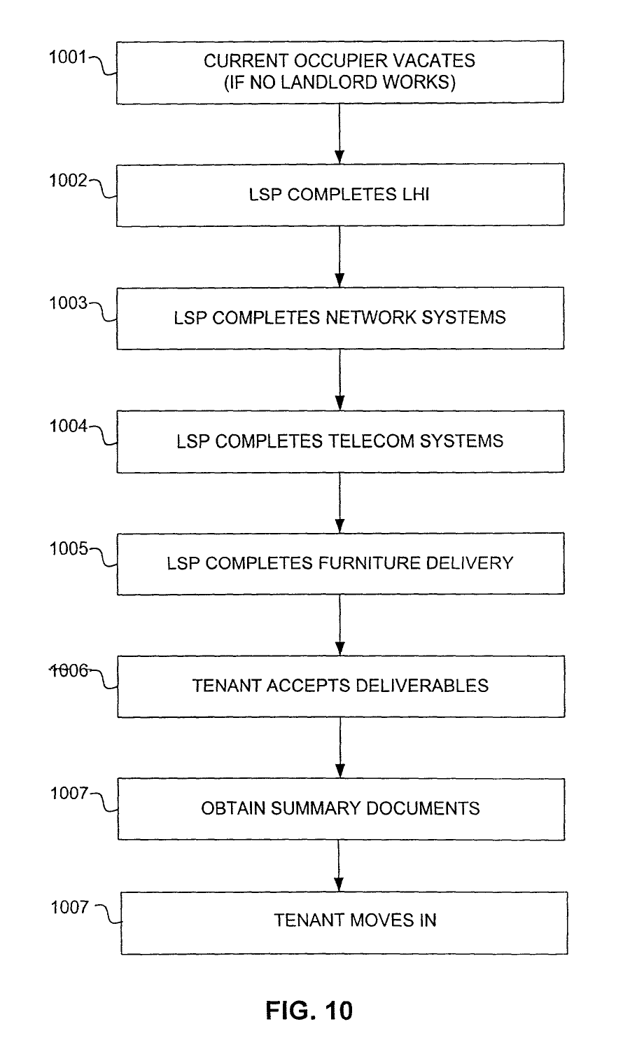

The eighth phase (complete tenant works) will be explained with reference to FIG. 10. The steps shown in FIG. 10 relate to works that the tenant is completing without assistance of the landlord. As such, the decisions in this phase involve only the tenant and its LSPs (although, in practice, the tenant may require the landlord's cooperation to resolve issues related to installation of tenant systems in the premises). Any steps that are completed by the landlord on behalf of the tenant in phase seven would be automatically eliminated from phase eight. Once all of the tenant's works are completed, the tenant would move into the new premises.

FIG. 16 shows a computer-generated lease proposal that can be filled in by one or both of the parties. In one variation of the invention, if the parties have already begun discussions, they could use a form such as that shown in FIG. 16 to enter information regarding the proposal without having to go through a more detailed agree/defer process illustrated in FIGS. 13 through 15.

The ninth phase (issue best practice report) will be explained with reference to FIGS. 11A-C. In this phase and according to one aspect of the present invention, the parties review the negotiation process and transaction process for evaluation purposes, particularly with a view to building a database that can be used by parties in future negotiations and future transactions. The processes illustrated in FIGS. 11A-C and described below can generally be used to generate and provide best practice reports and other reports for real estate transactions. Accordingly, the processes illustrated in FIGS. 11A-C are not limited to the ninth phase of a structured real estate transaction, and can independently function from other processes, such as a process including a real estate negotiation.

FIGS. 11A-C generally describe processes that can be implemented through software created using conventional programming techniques readily understood by one of ordinary skill in the art. The processes are generally described with respect to implementation through web pages provided by a web site over the Internet. It should be understood, however, that the processes can be implemented from any remote processing device over a computer network, or over a telephone or other network (e.g., cable TV, wireless, etc.).

FIG. 11A illustrates steps for receiving information, reviewing the received information, and generating a best practice report and project summary report. In step 1101, a user is prompted to provide information for generating a best practice report, and the information is transmitted to a remote computer, such as a web site, over a computer network. The information is received by the remote computer, and one or more best practice reports are generated from the information. For example, parties to a completed real estate transaction (e.g., lease, sale, purchase, assignment and the like) complete one or more on-line questionnaires, such as displayed on a web page, that solicit information concerning the completed transaction and concerning LSPs (e.g., real estate brokers, appraisers, lawyers, mediators, architects, contractor, etc.) used to complete the transaction.

On-line questionnaires can include a transaction questionnaire and an LSP questionnaire. The transaction questionnaire solicits information regarding the party's experience in completing the transaction and the current real estate market. Solicited information can include an evaluation of the difficulty in disposing/acquiring real estate; a description of local market conditions, practices and cultural issues; an evaluation of problems meeting scheduled dates; and identifying each LSP used to complete the transaction. Cultural issues can include, for example, whether individuals in a foreign country generally do not engage in business transactions on certain days during the week because of religious reasons. An LSP questionnaire for each LSP used to complete the transaction evaluates the service provided by each LSP. Solicited information can include an evaluation of the quality of professional advice provided; a description of the LSP's contribution to a solution; an evaluation of the LSP's impact on the scheduled delivery of the real estate which is the subject of the transaction; and a description of the LSP's role in coordinating with management to complete required tasks for completing the transaction. A transaction questionnaire and LSP questionnaire can be combined into a single questionnaire or provided distinctly. Also, a related transaction questionnaire and LSP questionnaire can include overlapping information, and overlapping information can be automatically incorporated into the latter completed questionnaire.

In step 1102, the received information is reviewed for determining whether all the necessary information has been received and whether any responses are clearly inappropriate (for example, responses that contain offensive language). This step can include a human reviewing responses or a computer-implemented step of flagging and substituting words for offensive, inappropriate, or misspelled words. Moreover, this step can be carried out at various points in the process although it is illustrated only at step 1102 in FIG. 11A. The questionnaires may include required fields that must be completed by the user. If all the required fields are not completed, the information for each non-completed, required field is requested (steps 1103 and 1104). Review of the received information can be performed by a system administrator and/or by a computer searching for information input in required fields and searching for key words or phrases that would trigger a further review process. The process of reviewing information submitted by users in connection with reports and summaries can be applied to various types of best practice reports; to project summaries; and to comments submitted for each. It may be desirable to review certain information automatically (e.g., a computer screens for offensive language or empty fields), while other information is reviewed by a human.

In step 1105, a best practice report is generated from the received information and stored in a database. In one variation, the best practice report is generated using a document template that extracts answers to questions in the questionnaires.

In step 1106, the user is requested to complete an optional project summary report that describes in detail the activities surrounding the completed transaction. The project summary report can be generated by the computer in a suggestive format (i.e., with a sample description of the requirement, the key responsibilities of the user, and the analysis) or in a menu format including sample phrases. The computer can assist the user by providing a simple format for making choices and suggesting certain phrases based upon keywords that were entered by the user. For example, if the user listed as a challenge “sourcing acceptable offices in a market with limited supply”, the computer may generate as a key responsibility “ensuring maximum review of all market opportunities including subleases”.

If the project summary report is not received within a predetermined period of time, the process is ended (steps 1107 and 1108). For example, the user indicates that a project summary report will be provided. If the project report is not received within, for example, seven days, the process is ceased and a project summary report is not stored. In another variation, if the project summary report has not been received within a first predetermined period of time (e.g., 5 days), the user is prompted to send a project summary report. Then, if the project summary report has not been received within a second predetermined period of time (e.g., 7 days), the process is ceased.

If the project summary report is received within the predetermined period of time, a determination is made as to whether revisions to the project summary report are necessary (step 1109). For example, a system administrator, such as one or more disinterested individuals, reviews the received project summary report and suggests or rejects language for the report. The administrator can suggest changes to language; reject offensive or inappropriate language; or make other changes to generally conform the report (and any comments) to other reports in the database.

Revisions are transmitted to the user for approval (step 1110). If the revisions are approved by the user (step 1111), the revised project summary report is stored in a database (step 1112). Approval of the revisions can be affirmatively indicated in a response transmitted by the user or can be constructively indicated when the user fails to respond within a predetermined time period. The stored project summary report can be linked to the related stored best practice report. For example, the reports can contain linking fields enabling a database to recognize that the reports are related. A related field can include the same identification number for each related report. Therefore, the reports can optionally be displayed together.

If the revisions are not approved by the user, the user can suggest alternative language or simply reject the revision. Then, steps 1109-1111 are repeated. For example, a system administrator determines whether the suggested alternative language is sufficient and/or whether revisions are still necessary (step 1109). Revisions are transmitted and rejected/approved (steps 110 and 111).

In step 1109, if no more revisions are necessary, the project summary report is stored in a database and linked to the related, stored, best practice report. Additionally, best practice reports and other reports related to the same transaction can be linked.

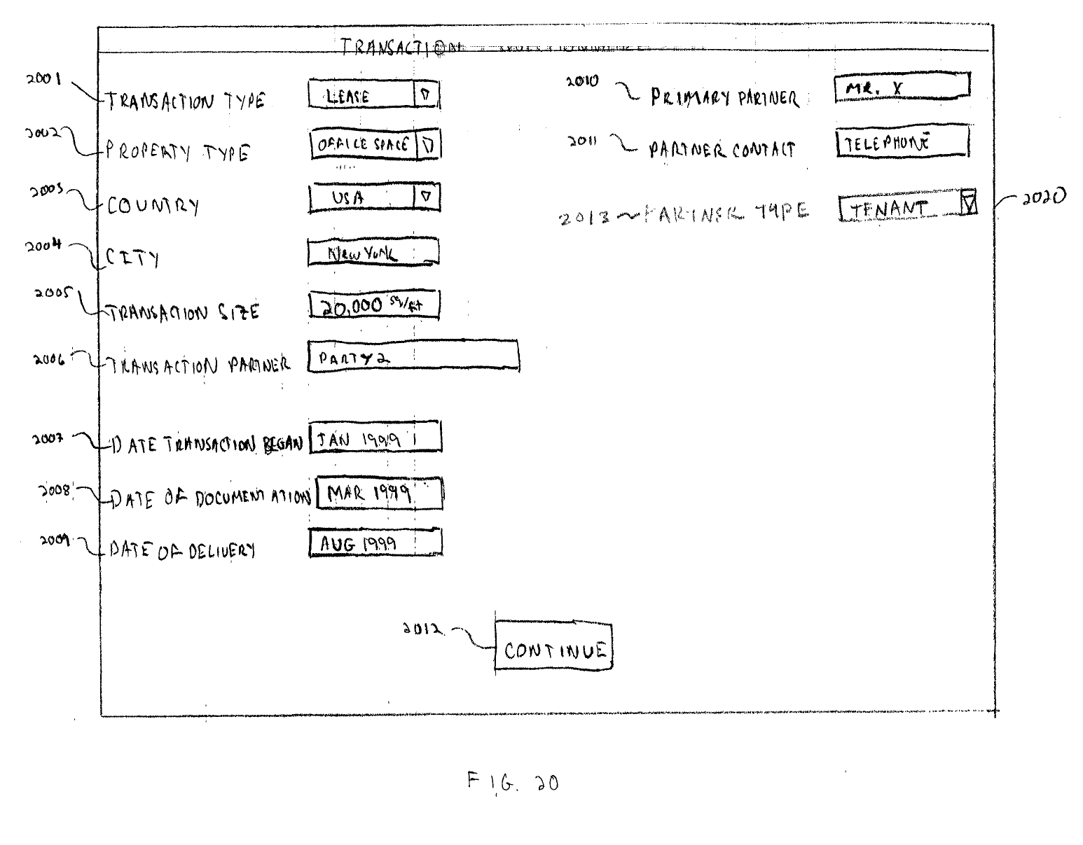

FIGS. 20-24 illustrate exemplary web-based computer screens generated by a web site that include a transaction and LSP questionnaire displayed to a user. The screens allow a user to input information for generating a best practice report. FIGS. 20-22 illustrate an exemplary transaction questionnaire completed by a user for a lease of office space. It will be assumed that a web-based computer display system using well-known hyperlink technology is used to display the web-based computer screens, although the invention is not limited in this respect.

Screen 2020, shown in FIG. 20, includes fields 2001-2013 that allow a user to input general information concerning a completed real estate transaction. A field in a web-based computer screen includes a section of the screen that requests or provides information. It should be understood that fields in the web-based computer screens are not limited to the formats illustrated in FIGS. 20-24 and can include one or more of drop-down menus, check lists providing preformatted selections, open text boxes and the like. Fields 2001-2004 are generally self-explanatory. Field 2005 requests the size of the real estate involved in the transaction. This value can automatically be converted by the web site into a unit of measurement commensurate with the input country. For example, a unit of measurement for each country can be stored in the database or a table. If information is not entered in the stored unit of measurement associated with the country previously input by the user, a processing device can use a conversion table to convert the entered information to the unit of measurement associated with the country. For example, square feet is converted to square meters for a country utilizing metric units of measurement.

Field 2006 requests the name of the other party to the transaction. Fields 2007-2009 relate to the dates of the transaction, such as the month/year of initial contact with the other party, month/year that the final legal contract was executed and the month/year the real estate was transferred or delivered (e.g., transfer date for owned property or delivery date for completion by the landlord of a tenant's leasehold improvement works). Fields 2010 and 2011 request the name of the primary contact of the other party and the primary means of contact. Field 2013 indicates the type of transaction partner (e.g., landlord, property owner, tenant, etc.) This field permits users accessing reports to view only reports concerning a certain type of partner that relates to their requirement.

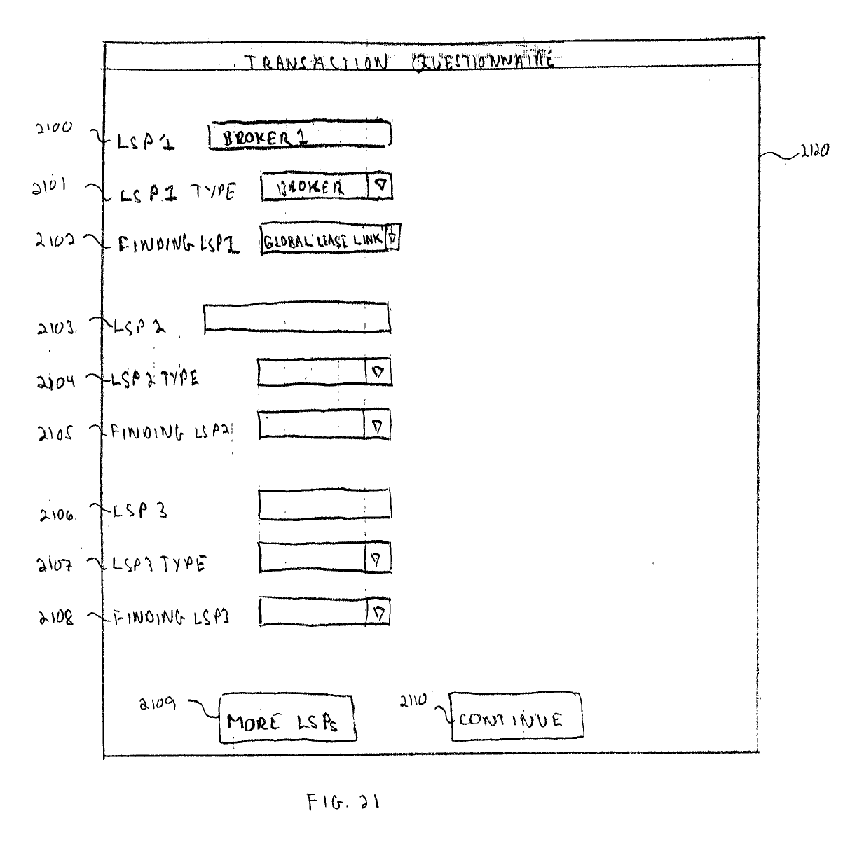

When the user has completed the fields, CONTINUE button 2012 is pressed, and web screen 2120, shown in FIG. 21, is displayed. One or more of the fields can be required fields that require input before the next web screen is displayed. If the required fields are not completed by the user, pressing CONTINUE button 2012 can cause a message to be displayed that requests completion of the required fields.

Web screen 2120, shown in FIG. 21, is a continuation of the transaction questionnaire. Information for each LSP used to complete the transaction is input via fields 2100-2108. Information is input in three fields (e.g., 2100-2102) for each LSP used to complete the transaction. Field 2100 requests the name of one LSP. Field 2101 requests the type of the LSP, and field 2102 requests how the LSP was found. For example, if the LSP was found through a service offered in conjunction with a service providing the best practice reports and leasing services (e.g., a service named Global Lease Link), the service name is input in field 2102. It should be understood that a service providing best practice reports in accordance with the present inventions can be practiced independently from other services (e.g., Global Lease Link). Field 2102 can include a drop-down menu providing other options, such as found locally or found through network contacts.

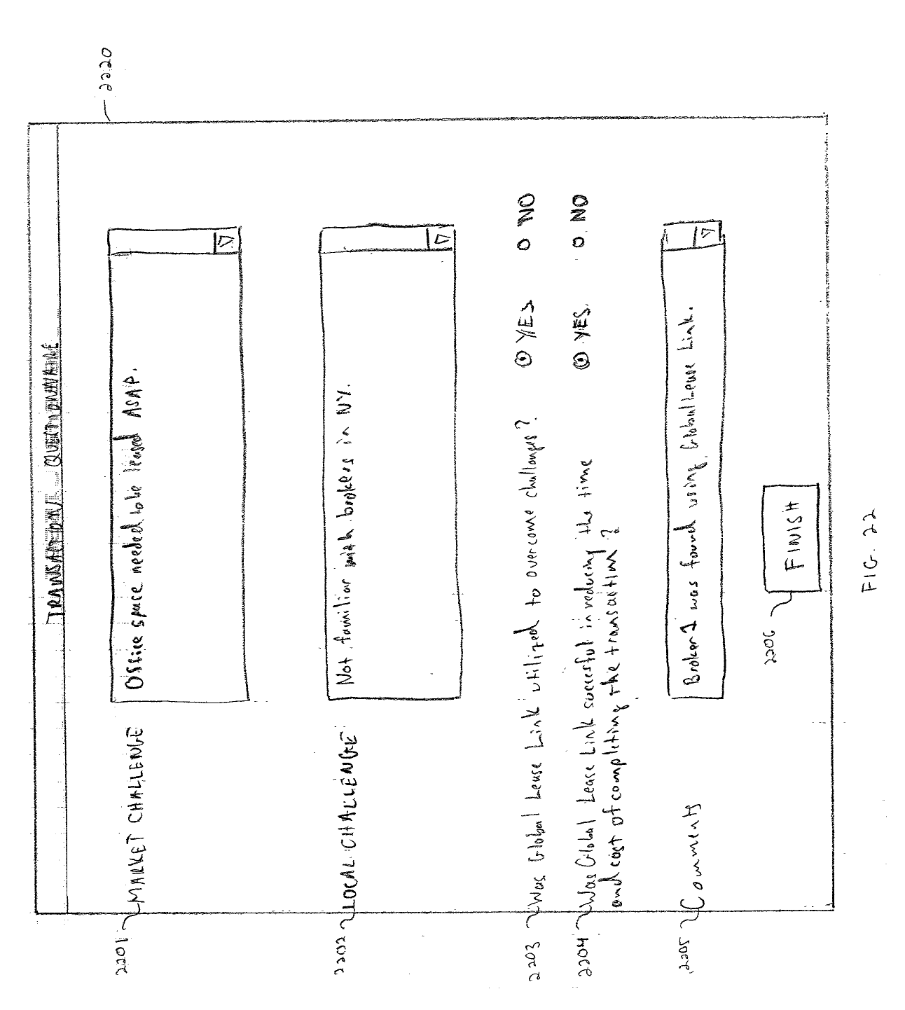

A user can input information for one to three LSPs via web screen 2020. If more LSPs were used, the user can depress MORE LSPs button 2109 for more fields. When all the information is input for each LSP, CONTINUE button 2110 is pressed and web screen 2220, shown in FIG. 22, is displayed.

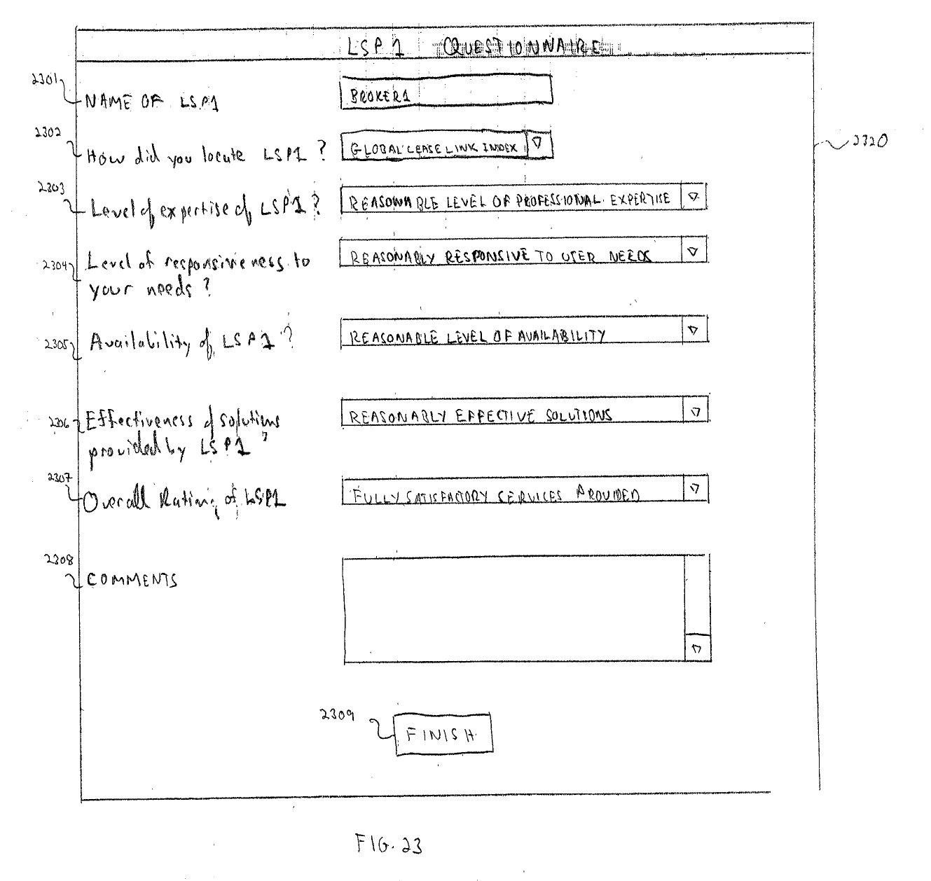

Web screen 2220 is a continuation of the transaction questionnaire. Field 2201 requests comments regarding general challenges the party encountered to complete the transaction. Field 2202 requests comments regarding challenges specific to the local market where the real estate is located. Fields 2203 and 2204 request information on whether a specific service (e.g., Global Lease Link) was used and how effective the service was. Field 2205 requests any additional comments. After a user completes all the necessary information (e.g., one or more fields, such as field 2205, may not be required to be completed, depending on the discretion of the service provider providing the best practice reports to users) in the transaction questionnaire, the user presses FINISH button 2206. Then, if at least one LSP was used to complete the transaction, web screen 2320, shown in FIG. 23, is displayed.

Web screen 2320 illustrates an exemplary LSP questionnaire for soliciting input from users regarding the service provided by an LSP. Field 2301 displays the name of the LSP. This field may automatically be completed by the web site, when this information was provided via the transaction questionnaire. Although not shown, other fields completed by the web site (e.g., listing ID, property type, transaction type, country city, transaction size date transaction began, date of documentation, date of delivery etc.) can be displayed. A listing ID can include a number or other designation assigned by the web site to the information stored for each transaction questionnaire and each LSP questionnaire completed. A listing ID can be displayed as the information is input via the questionnaire or stored with each generated best practice report. A user can quickly retrieve a best practice report by identifying the listing ID.

Fields 2302-2307 can include drop-down menus providing preformatted selections for each question. Field 2302 requests information regarding how the LSP was located and can include the following preformatted selections: previously used serve provider, Global Lease Link index, referral from registered user and other referral.

Field 2303 requests information regarding the perceived level of expertise of the LSP and can include the following preformatted selections: high level, reasonable level and low level of expertise.

Field 2304 requests information regarding the perceived level of responsiveness of the LSP to the party's needs and can include the following preformatted selections: highly responsive, reasonably responsive and not very responsive.

Field 2305 requests information regarding the perceived level of availability of the LSP to meet with the party or contact the party and can include the following preformatted selections: high level, reasonable level and low level of availability.

Field 2306 requests information regarding the LSP's effectiveness in providing solutions to the party's needs and can include the following preformatted selections: highly effective, reasonably effective and not very effective.

Field 2307 requests information regarding the party's overall opinion of the LSP's service and can include the following preformatted selections: excellent, highly satisfactory, fully satisfactory, less than fully satisfactory and unsatisfactory services provided. It will be appreciated that other techniques for rating LSPs (e.g., numerical scales) can instead be used.

Field 2308 requests any additional comments concerning the LSP. After the user completes all the necessary fields, the user depresses FINISH button 2309. If more than one LSP was used to complete the transaction, as determined by the LSP information provided via the transaction questionnaire, another LSP questionnaire is displayed for each LSP used. Then a best practice report including the information from the transaction questionnaire and the LSP questionnaire is generated and stored in a database. Alternatively, a best practice report is generated and stored after the transaction questionnaire is completed, and another best practice report is generated and stored after one or more LSP questionnaires are completed. Also, information from the transaction questionnaire and the LSP questionnaire(s) can be stored as a single best practice report or multiple best practice reports linked together.

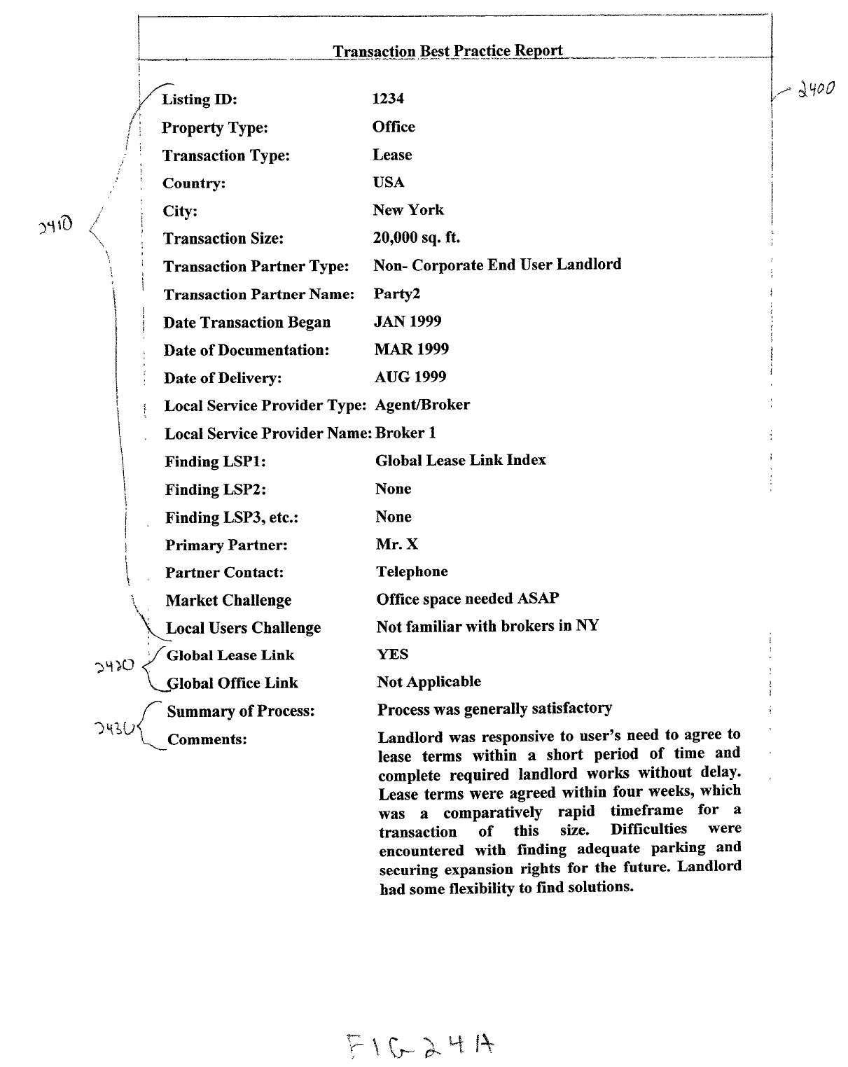

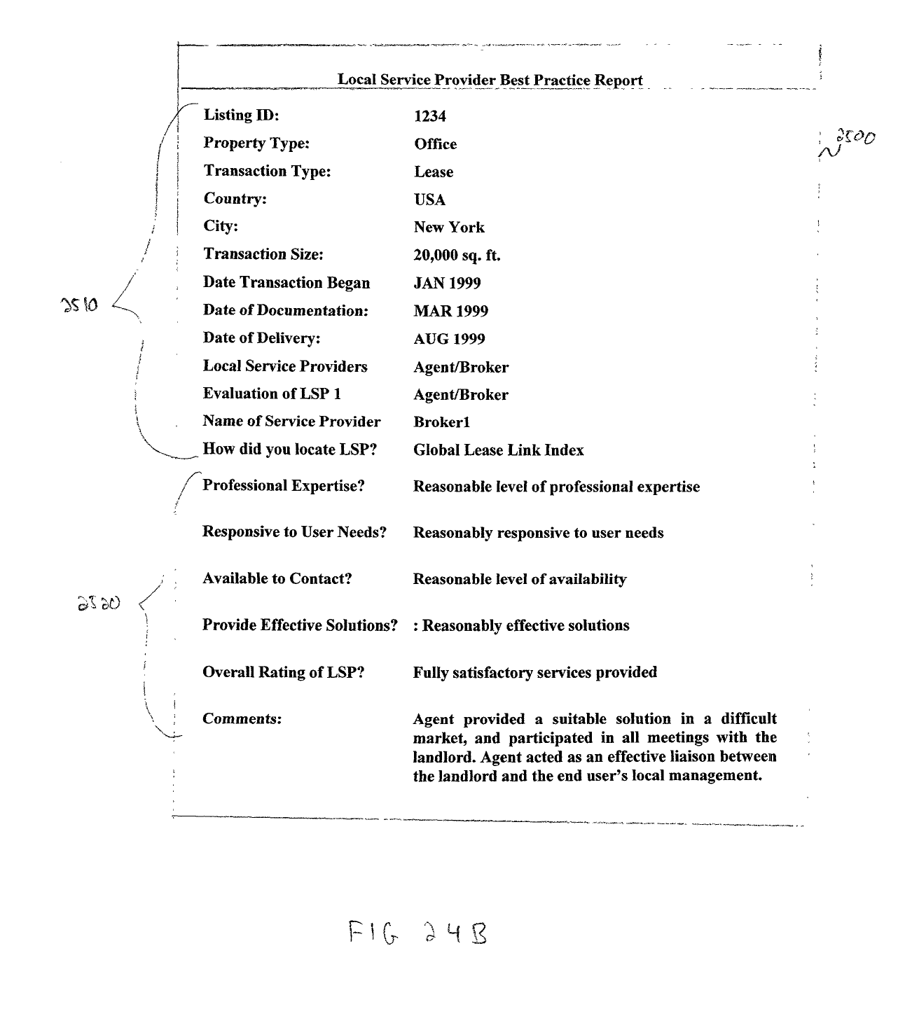

FIGS. 24A and 24B illustrates exemplary best practice reports. Web screen 2400, shown in FIG. 24A, illustrates a transaction best practice report generated from information in a transaction questionnaire and/or user registration information. Web screen 2400 includes fields 2410 providing general information regarding, among other things, the real estate involved in the transaction, transaction dates and information regarding LSPs used to complete the transaction. Fields 2420 describe whether particular services (e.g., Global Lease Link and Global Office Link) were used to find the LSPs and/or complete the transaction. Fields 2430 rate the process for completing the transaction and include comments from the user.

Web screen 2500, shown in FIG. 24B, illustrates an LSP best practice report generated from information in an LSP questionnaire and/or registration information. Fields 2510 generally include background information for a real estate transaction that the LSP was used for, and fields 2520 generally include an evaluation of the LSP by a user.

Although not shown, a single best practice report combining the information in the transaction best practice report and the LSP best practice report can be generated. The information in the best practice report can be input and displayed anonymously (e.g., without identifying the user providing the information for the best practice report) to promote candid responses provided via the questionnaires. In another variation, a user's identity can be disclosed to certain categories of inquiring parties (e.g., to other corporate end users).

It should be understood that the fields illustrated for the transaction and LSP questionnaires and best practice report are by no means exhaustive or exclusive, and other information can be requested from the user for generating comprehensive best practice reports. Moreover, information can be displayed in languages other than English for accommodating users globally.

FIG. 11B illustrates a process for accessing stored best practice reports. In step 1130 a user registers. For example, a user registers with a web site providing the best practice reports. As is known in the art, the registration process can include the user providing personal/business information, login name and password. A user can be required to register to have access to stored best practice reports. The registration information is stored at the web site.

In step 1131, a determination is made whether a user is a registered LSP. For example, the user logs into the web site providing access to the best practice reports. The web site retrieves stored registration information associated with the user's login name for determining whether the user is a LSP registered with the web site. If the user is a registered LSP, the LSP may only have access to limited information (see step 1150 in FIG. 11 C).

If the user is not a registered LSP, user input for selecting one or more best practice reports desired to be viewed by the user is received (step 1132). For example, via a web page, the user selects criteria for selecting best practice reports. Criteria includes, for example, city, country, name/type of LSP, type of transaction, party to transaction and the like.

In step 1133, best practice reports that meet the received criteria are retrieved from a database. For example, a query is created using the received criteria for retrieving best practice reports from the database. In one variation, users that are not registered or which fall into certain user categories are not eligible to access best practice reports or have restricted access to the reports.

In step 1134, one or more best practice reports that meet the criteria are transmitted to the user. In one variation, a list of titles and/or one-line summaries of the best practice reports that meet the received criteria are displayed to the user on a web page. A user selects the titles from the web page that correspond to best practice reports that are desired to be reviewed. Best practice reports corresponding to the selected titles are retrieved from the database and displayed to the user.

The user can optionally select other related reports to review. For example, titles and/or one-line summaries for project summary reports, reports containing additional comments provided by third parties and other related best practice reports that are linked to the best practice reports that meet the received criteria are displayed. A user can select any one of the related reports (similarly to selecting a best practice report) and the reports are transmitted/displayed to the user.

Linking of reports can be performed automatically by a computer program. For example, a program generating a report can code a field in the report with an identifier. All reports that are generated using information related to, for example, a single transaction or LSP, are automatically coded with the same identifier. Therefore, a computer program can retrieve all related reports stored in the database using the identifier as a search criteria when the identifier is identified from one of the related reports.

In step 1135, an additional comment report may be received from the user. A user viewing a best practice report can send an additional comment report including comments related to a best practice report. For example, a user may have had a similar experience with one of the parties to a transaction evaluated in a best practice report or with an LSP used to complete a transaction or the LSP that was the subject of an evaluation may wish to comment on their evaluation. The user can select a button on a web page for preparing an additional comment report. A text box is displayed and the user inputs comments regarding the user's experience with the party. (As before, these comments may be subject to review and/or revision by a disinterested third party such as a system administrator). The comments can be saved as an additional comment report in a database and linked to the best practice report (step 1136). If no additional comment report is received, the process is ceased (step 1137).

FIG. 11C illustrates a process for providing summarized information (i.e., LSP summary reports) to LSPs that desire to access information in best practice reports. As described above, best practice reports include evaluations of LSPs. Therefore, LSPs may desire to access best practice reports to evaluate their performance. However, to protect anonymity and encourage candid responses by users, LSPs are provided access to limited, summarized information (i.e., LSP summary reports) from stored best practice reports.

In step 1149, an LSP registers. For example, as described above, the LSP registers with the web site providing the best practice reports. As is known in the art, the registration process can include the LSP providing personal/business information, login name and password. An LSP can be required to register to have access to LSP summary reports.

In step 1150, a determination is made as to whether the LSP has been evaluated by a predetermined number of different users for preserving anonymity of the users evaluating the LSPs in best practice reports. For example, the LSP logs into the web site providing access to the best practice reports. Then, best practice reports evaluating the LSP are queried and the number of different users that evaluated the LSP in best practice reports is determined. If the number of different users exceeds a predetermined amount, e.g., two, an LSP summary report including a summary of each best practice report evaluating the LSP is transmitted to the LSP (e.g., displayed on a web page) (step 1151). To preserve anonymity, the LSP summary report may not include information identifying the user providing the evaluation. Additionally, information in the LSP summary report can be limited to the information provided via standardized responses (e.g., dropdown menus or check lists) in the questionnaires to further preserve the anonymity of users providing information for best practice reports. To protect the anonymity of subsequent users submitting reports, the computer may reset the calculation of the number of LSP evaluation reports received to zero so that LSPs would need to wait until more than a certain number of new reports had been submitted before again receiving access to the reports. The LSP summary report can be stored in a database with the best practice reports.

If the LSP has not been evaluated by a predetermined number of different users, the LSP does not receive an LSP summary report (step 1152). A message can be displayed indicating that an LSP summary report is not available due to the limited number of evaluations. In one variation, the user generating the report may either waive the requirement for a predetermined minimum number of evaluations, or may waive the requirement for provision of a summary report rather than complete the report.

In step 1153, an LSP comment report can be received from the LSP receiving the LSP summary report. Similar to the additional comment report described with respect to step 1135, an LSP reviewing an LSP summary report can send an LSP comment report including comments related to the evaluation(s) or more general comments about market practices that, for example, may have effected the evaluation(s). For example, an LSP may have a comment regarding experiences working with a user that may have effected the evaluation of the LSP. The LSP can select a button on a web page for preparing an LSP comment report. A text box is displayed and the LSP inputs comments. The comments can be saved as an LSP comment report in a database and linked to a best practice report (step 1154) subject to review of the process by a system administrator. If no LSP comment report is received, the process is ceased (step 1152). As there is potential for a large number of comments, comments can be sorted for a particular report or ID number by type of report, date, and type of user.

It should be understood that LSP best practice reports, LSP summary reports and LSP comment reports can also be provided for other types of users, such as landlords, tenants, real estate owners/purchasers and the like, and the methods and apparatus described above is applicable for providing best practice reports for other types of users. For example, a user, such as a landlord/tenant, real estate owner/purchaser and the like, can be evaluated in a best practice report, similar to an LSP best practice report. The user maybe able to receive a summary best practice report, similar to an LSP summary report, and the user can provide comments for a comment report, similar to an LSP comment report.

It should also be appreciated that although the invention has been described primarily by way of examples using a computer network to receive and transmit information used in various types of reports, some or all of such information can also be communicated over a telephone network using voice recognition technology. For example, parties to a transaction can provide responses over a telephone line or microphone into a computer, and the computer would then transcribe the responses into text. Users could use the same technique for retrieving reports relating to real estate transactions without departing from the inventive principles.

Thus has been described a system and methods for negotiating a lease using a computer network and providing best practice reports for real estate transactions. Reference numerals in the appended method claims identifying steps are for convenience only and are not intended to imply a necessary ordering of the steps. It is, therefore, to be understood that within the scope of the appended claims the invention may be practiced otherwise than as specifically described. No claim should be interpreted to be in means-plus-function format.

1. A method of generating a report regarding a completed real estate transaction, comprising the steps of:
(1) receiving over a computer network from one or more parties to the completed real estate transaction information relating to the completed real estate transaction;
(2) generating a transaction report based on the received information;
(3) storing the transaction report in a computer storage device; and
(4) in response to a query by a third-party user, transmitting the transaction report over the computer network to the third-party user.

2. The method of claim 1, wherein step (1) further comprises the step of receiving a transaction questionnaire including information evaluating the real estate transaction and information identifying at least one local service provider that assisted with one or more aspects of the real estate transaction.

3. The method of claim 2, wherein step (1) further comprises the step of receiving an evaluation questionnaire including an evaluation of the at least one local service provider, and
wherein step (4) comprises the step of transmitting the evaluation of the at least one local service provider.

4. The method of claim 1, wherein step (1) further comprises the step of receiving an evaluation questionnaire including an evaluation of another party to the completed real estate transaction, and
wherein step (4) comprises the step of transmitting the transaction report including transmitting the evaluation of the another party to the completed real estate transaction.

5. The method of claim 1, wherein step (1) further comprises the step of receiving an evaluation questionnaire including an evaluation of local challenges encountered during the real estate transaction, and
wherein step (4) comprises the step of transmitting the transaction report including transmitting the evaluation of local challenges encountered during the real estate transaction.

6. The method of claim 2, further comprising the steps of:
determining whether information for a plurality of required fields in the questionnaire is received;
when information for at least one of the plurality of required fields is not received, prompting a user to input the information for the at least one required field; and
when information for each of the plurality of required fields is received, prompting a user to complete a project summary report, the project summary report including a description of tasks required to complete the real estate transaction.

7. The method of claim 6, further comprising the steps of:
receiving the project summary report; and
an outsider to the completed real estate transaction reviewing the project summary report.

8. The method of claim 5, further comprising the steps of:
the outsider revising the project summary report; and
transmitting at least one revision to the party completing the project summary report.

9. The method of claim 8, further comprising the step of, when the party completing the project summary report confirms the at least one revision, storing the project summary report and linking the stored project summary report with the stored transaction report.

10. The method of claim 6, further comprising the step of, when a response to the at least one transmitted revision is not received within a predetermined length of time, storing the project summary report and linking the stored project summary report with the stored transaction report.

11. The method of claim 1, further comprising the steps of:
receiving a comment report after the transaction report is transmitted, the comment report including at least one comment related to the information in the transmitted transaction report;
storing the comment report; and
linking the comment report to the stored transaction report.

12. The method of claim 1, wherein step (3) further comprises the step of storing a plurality of transaction reports related to a plurality of real estate transactions.

13. The method of claim 1, wherein step (4) further comprises the steps of:
receiving user input criteria including one or more of a country, city and type of report; and
transmitting at least one of the plurality of transaction reports that meet the user input criteria.

14. The method of claim 12, wherein step (4) further comprises the steps of:
when the user is a local service provider, determining whether a plurality of transaction reports having information evaluating the local service provider are stored in the database; and
when a plurality of transaction reports are stored in the database, transmitting an LSP summary report including limited information from the stored multiple transaction reports related to the local service provider.

15. The method of claim 14, further comprising the steps of:
receiving a local service provider comment report from the local service provider including at least one comment related to information in the LSP summary report;
storing the local service provider comment report; and
linking the local service provider comment report to the plurality of transaction reports having information evaluating the local service provider.

16. A system for generating a transaction report for a completed real estate transaction, the system comprising:
a computer programmed with software that generates at least one display to receive information related to the real estate transaction from one or more parties to the completed real estate transaction, the computer system generating at least one transaction report from the received information and transmitting the transaction report over a computer network to a third-party user in response to a request; and
a database that stores the at least one transaction report.

17. The system of claim 16, wherein the at least one display includes a transaction questionnaire that facilitates receipt of information evaluating the real estate transaction and information identifying at least one local service provider that assisted with completion of at least part of the real estate transaction.

18. The system of claim 17, wherein the at least one display includes an evaluation questionnaire that facilitates receipt of information evaluating service provided by the at least one local service provider.

19. The system of claim 18, wherein the software performs the steps of:
determining whether information for a plurality of required fields in the transaction questionnaire and the evaluation questionnaire is received;
when information for at least one of the plurality of required fields is not received, prompting the user to input the information for the at least one required field; and
when information for each of the plurality of required fields is received, prompting the user to complete a project summary report, the project summary report including a description of tasks required to complete the real estate transaction.

20. The system of claim 19, wherein the computer system stores the project summary in the database and links the project summary report to the transaction report.

21. The system of claim 16, wherein the computer system receives a comment report after the transaction report is transmitted, the comment report including at least one comment related to the information in the transmitted transaction report.

22. The system of claim 21, wherein the computer system stores the comment report in the database and links the comment report to the transaction report.

23. The system of claim 16, wherein the database stores a plurality of transaction reports related to a plurality of real estate transactions.

24. The system of claim 23, wherein the computer system receives user input criteria including one or more of a country, city and type of report and transmits at least one stored transaction report that meets the user input criteria.

25. The system of claim 16, wherein the computer system determines whether the user is a local service provider and, when the user is a local service provider, determines whether multiple transaction reports generated from information received from a predetermined number of different users and having information related to the local service provider are stored in the database; and
when multiple transaction reports generated from information received from a minimum number of different users are stored in the database, transmits an LSP summary report including limited information from the stored multiple transaction reports related to the local service provider.

26. The system of claim 25, wherein the computer system receives a local service provider comment report from the local service provider including at least one comment related to information in the LSP summary report; and the local service provider comment report is stored in the database and linked to the multiple transaction reports having information related to the local service provider.

27. The system of claim 16, wherein the software generates a transaction report from the transaction questionnaire and generates an LSP summary report from the LSP questionnaire.

28. A computer-readable medium comprising computer-executable instructions which, when executed by a computer, perform the steps of:
(1) receiving in the computer from one or more parties to a completed real estate transaction information relating to the completed real estate transaction;
(2) generating a transaction report based on the received information;
(3) storing the transaction report in a computer storage device; and
(4) in response to a query by a third-party user, transmitting the transaction report over a computer network to the third-party user.

29. The computer-readable medium of claim 28, wherein step (1) is performed using a telephone.
